(19) United States
(12) Patent Application Publication
(10) Pub. No.: US 2015/0084573 A1
(43) Pub. Date: Mar. 26, 2015

(54) STEPPING MOTOR AND TIMEPIECE PROVIDED WITH STEPPING MOTOR

(71) Applicant: CASIO COMPUTER CO., LTD., Tokyo (JP)

(72) Inventors: Yuta SAITO, Tokyo (JP); Yohei KAWAGUCHI, Tokyo (JP)

(73) Assignee: CASIO COMPUTER CO., LTD., Tokyo (JP)

(21) Appl. No.: 14/476,375

(22) Filed: Sep. 3, 2014

(30) Foreign Application Priority Data
Sep. 20, 2013 (JP) 2013-195429
Jul. 14, 2014 (JP) 2014-144111

(51) Int. Cl. H02P 8/12

(52) U.S. Cl. CPC H02P 8/12
USPC 318/696

(57) ABSTRACT

Disclosed is a stepping motor including a rotor including a cylindrical rotor magnet having an M number of magnetization, M being an even number, in a radial direction, and a stator including a stator body and a coil, the stator body having a rotor accommodating space which accommodates the rotor and an N number of magnetic poles, N being an odd number, disposed along an outer periphery of the rotor, and the coil being magnetically coupled with the stator body. Further including rotor stoppers disposed at every predetermined rotation angle which is smaller than an angle obtained by dividing one rotation by a product of the N and the M and a driving pulse supplying circuit which applies driving pulses to rotate the rotor by the predetermined rotation angle to the coil.

### BACKGROUND OF THE INVENTION

1. Field of the Invention

The present invention relates to a stepping motor and a timepiece provided with the stepping motor.

2. Description of Related Art

There is known a stepping motor having two coils rotatable in normal and reverse directions by driving pulses applied to the coils as appropriate.

For example, JP H05-006440 discloses a stepping motor including a rotor magnet and a stator. The rotor magnet is substantially circular and bipolarly magnetized. The stator has two main magnetic poles and one subsidiary magnetic pole.

The rotational torque of a stepping motor depends on the peak level of its index torque (holding torque). Decreasing a rotation angle (step angle) per step of the rotor while maintaining the level of the index torque would enable the motor to produce sufficiently high rotational torque with low current consumption.

Since it is difficult for a conventional circular bipolarly magnetized rotor magnet used in a compact stepping motor to generate index torque (holding torque) per step that provides at least three stable resting positions of the rotor, the conventional stepping motor cannot have a rotation angle (step angle) less than 180 degrees.

As a result, a large quantity of energy is required to rotate the rotor beyond the peak level of index torque to the next stable resting position, resulting in increased current consumption.

In this respect, a rotor magnet which is multipolarly magnetized with a mold and a magnetizer that can produce a complicated magnetic field enables the rotor to rotate at a fine rotation angle through an increase in the number of poles of the rotor magnet.

Unfortunately, the production of multipolarly magnetized rotor magnets requires more complicated and expensive molds and magnetizers as compared to that of the bipolarly magnetized rotor magnets.

In addition, if the stepping motor is used as a power source of a compact device such as a watch, the rotor magnet should be miniaturized as much as possible; however, production of compact multipolarly magnetized rotor magnets is significantly difficult.

From a manufacturing point of view, it is preferred that rotor magnets of stepping motors for use in compact devices be bipolarly magnetized.

One possible approach to decrease the rotation angle (step angle) per step of the rotor with a bipolarly magnetized rotor magnet is to significantly complicate the shape of the rotor magnet.

The shape suitable for miniaturization of the rotor magnet is cylindrical or cubic from a manufacturing point of view. This indicates that significantly complicated shapes of the rotor magnets preclude their miniaturization.

### SUMMARY OF THE INVENTION

In view of the circumstances mentioned above, an object of the present invention is to provide a stepping motor including a substantially cylindrical rotor magnet and having a reduced rotation angle (step angle) per step of a rotor and a timepiece including the stepping motor. The stepping motor can be readily manufactured and be driven at low current consumption.

In order to achieve the above objects, one aspect of the present invention is a stepping motor including a rotor including a cylindrical rotor magnet having an M number of magnetization, M being an even number, in a radial direction, a stator including a stator body and a coil, the stator body having a rotor accommodating space which accommodates the rotor and an N number of magnetic poles, N being an odd number, disposed along an outer periphery of the rotor, and the coil being magnetically coupled with the stator body, rotor stoppers disposed at every predetermined rotation angle which is smaller than an angle obtained by dividing one rotation by a product of the N and the M, and a driving pulse supplying circuit which applies driving pulses to rotate the rotor by the predetermined rotation angle to the coil.

In order to achieve the above objects, another aspect of the present invention is a timepiece including a stepping motor which includes a rotor including a cylindrical rotor magnet having an M number of magnetization, M being an even number, in a radial direction, a stator including a stator body and a coil, the stator body having a rotor accommodating space which accommodates the rotor and an N number of magnetic poles, N being an odd number, disposed along an outer periphery of the rotor, and the coil being magnetically coupled with the stator body, rotor stoppers disposed at every predetermined rotation angle which is smaller than an angle obtained by dividing one rotation by a product of the N and the M, and a driving pulse supplying circuit which applies driving pulses to rotate the rotor by the predetermined rotation angle to the coil.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a plan view of a stepping motor in accordance with an embodiment of the present invention;

FIG. 2A is an enlarged view of the main portion of the stepping motor provided with three stator-side notches;

FIG. 2B is a graph showing peaks of the index torque of the stepping motor shown in FIG. 2A;

FIG. 3A is an enlarged view of the main portion of the stepping motor provided with twelve stator-side notches;

FIG. 3B is a graph showing peaks of the index torque of the stepping motor shown in FIG. 3A;

FIG. 4 is a schematic block diagram illustrating a mechanism for applying driving pulses to a first coil and a second coil of the stepping motor shown in FIG. 1;

FIG. 5 is a graph showing variations in torque at different application patterns;

FIG. 6 is a timing chart illustrating application of the driving pulses in accordance with a first embodiment of the present invention;

FIGS. 7A, 7B, 7C and 7D are plan views of the stepping motor illustrating states where the rotor is rotated in accordance with the manner of applying the driving pulses as shown in FIG. 6; FIG. 7A illustrates a state where the rotor is at an initial position, FIG. 7B illustrates a state where the rotor is rotated 30 degrees, FIG. 7C illustrates a state where the rotor is rotated 60 degrees and FIG. 7D illustrates a state where the rotor is rotated 90 degrees;

FIGS. 8A, 8B, 8C and 8D are plan views of the stepping motor illustrating states where the rotor is rotated in accordance with the manner of applying the driving pulses as shown in FIG. 6; FIG. 8A illustrates a state where the rotor is rotated 120 degrees, FIG. 8B illustrates a state where the rotor is rotated 150 degrees, FIG. 8C illustrates a state where the rotor is rotated 180 degrees and FIG. 8D illustrates a state where the rotor is rotated 210 degrees;

FIGS. 9A, 9B, 9C and 9D are plan views of the stepping motor illustrating states where the rotor is rotated in accordance with the manner of applying the driving pulses as shown in FIG. 6; FIG. 9A illustrates a state where the rotor is rotated 240 degrees, FIG. 9B illustrates a state where the rotor is rotated 270 degrees, FIG. 9C illustrates a state where the rotor is rotated 300 degrees and FIG. 9D illustrates a state where the rotor is rotated 330 degrees;

FIG. 10 is a timing chart illustrating application of the driving pulses in accordance with a second embodiment of the present invention;

FIGS. 11A, 11B, 11C and 11D are plan views of the stepping motor illustrating states where the rotor is rotated in accordance with the manner of applying the driving pulses as shown in FIG. 10; FIG. 11A illustrates a state where the rotor is at an initial position, FIG. 11B illustrates a state where the rotor is rotated 30 degrees, FIG. 11C illustrates a state where the rotor is rotated 60 degrees and FIG. 11D illustrates a state where the rotor is rotated 90 degrees;

FIGS. 12A, 12B, 12C and 12D are plan views of the stepping motor illustrating states where the rotor is rotated in accordance with the manner of applying the driving pulses as shown in FIG. 10; FIG. 12A illustrates a state where the rotor is rotated 120 degrees, FIG. 12B illustrates a state where the rotor is rotated 150 degrees, FIG. 12C illustrates a state where the rotor is rotated 180 degrees and FIG. 12D illustrates a state where the rotor is rotated 210 degrees;

FIGS. 13A, 13B, 13C and 13D are plan views of the stepping motor illustrating states where the rotor is rotated in accordance with the manner of applying the driving pulses as shown in FIG. 10; FIG. 13A illustrates a state where the rotor is rotated 240 degrees, FIG. 13B illustrates a state where the rotor is rotated 270 degrees, FIG. 13C illustrates a state where the rotor is rotated 300 degrees and FIG. 13D illustrates a state where the rotor is rotated 330 degrees;

FIG. 14 is a timing chart illustrating application of the driving pulses in accordance with a third embodiment of the present invention;

FIGS. 15A, 15B, 15C and 15D are plan views of the stepping motor illustrating states where the rotor is rotated in accordance with the manner of applying the driving pulses as shown in FIG. 14; FIG. 15A illustrates a state where the rotor is at an initial position, FIG. 15B illustrates a state where the rotor is rotated 30 degrees, FIG. 15C illustrates a state where the rotor is rotated 60 degrees and FIG. 15D illustrates a state where the rotor is rotated 90 degrees;

FIGS. 16A, 16B, 16C and 16D are plan views of the stepping motor illustrating states where the rotor is rotated in accordance with the manner of applying the driving pulses as shown in FIG. 14; FIG. 16A illustrates a state where the rotor is rotated 120 degrees, FIG. 16B illustrates a state where the rotor is rotated 150 degrees, FIG. 16C illustrates a state where the rotor is rotated 180 degrees and FIG. 16D illustrates a state where the rotor is rotated 210 degrees;

FIGS. 17A, 17B, 17C and 17D are plan views of the stepping motor illustrating states where the rotor is rotated in accordance with the manner of applying the driving pulses as shown in FIG. 14; FIG. 17A illustrates a state where the rotor is rotated 240 degrees, FIG. 17B illustrates a state where the rotor is rotated 270 degrees, FIG. 17C illustrates a state where the rotor is rotated 300 degrees and FIG. 17D illustrates a state where the rotor is rotated 330 degrees;

FIG. 18 is a timing chart illustrating application of the driving pulses in accordance with a fourth embodiment of the present invention;

FIGS. 19A, 19B, 19C and 19D are plan views of the stepping motor illustrating states where the rotor is rotated in accordance with the manner of applying the driving pulses as shown in FIG. 18; FIG. 19A illustrates a state where the rotor is at an initial position, FIG. 19B illustrates a state where the rotor is rotated 30 degrees, FIG. 19C illustrates a state where the rotor is rotated 60 degrees and FIG. 19D illustrates a state where the rotor is rotated 90 degrees;

FIGS. 20A, 20B, 20C and 20D are plan views of the stepping motor illustrating states where the rotor is rotated in accordance with the manner of applying the driving pulses as shown in FIG. 18; FIG. 20A illustrates a state where the rotor is rotated 120 degrees, FIG. 20B illustrates a state where the rotor is rotated 150 degrees, FIG. 20C illustrates a state where the rotor is rotated 180 degrees and FIG. 20C illustrates a state where the rotor is rotated 210 degrees;

FIGS. 21A, 21B, 21C and 21D are plan views of the stepping motor illustrating states where the rotor is rotated in accordance with the manner of applying the driving pulses as shown in FIG. 18; FIG. 21A illustrates a state where the rotor is rotated 240 degrees, FIG. 21B illustrates a state where the rotor is rotated 270 degrees, FIG. 21C illustrates a state where the rotor is rotated 300 degrees and FIG. 21D illustrates a state where the rotor is rotated 330 degrees; and

FIG. 22 is a plan view illustrating an example timepiece including the stepping motor shown in the embodiments.

### DESCRIPTION OF THE PREFERRED EMBODIMENTS

### First Embodiment

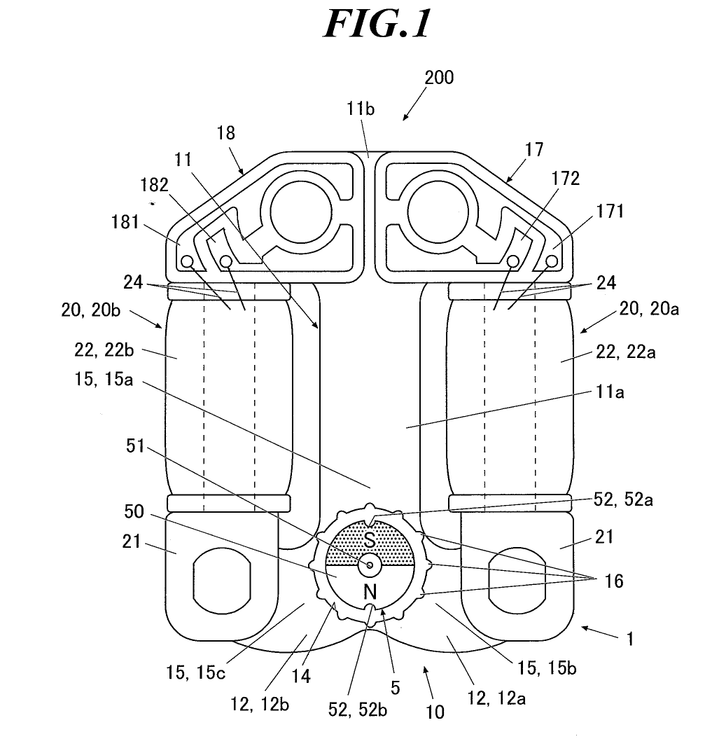

With reference to FIG. 1 to FIGS. 9A to 9D, a stepping motor will now be described in accordance with a first embodiment of the present invention. An example stepping motor used in this embodiment includes a compact motor that drives a hand driving mechanism to rotate hands of a watch and a date indicating mechanism to display the date. The stepping motor used in the present invention can also be applied to any other field.

FIG. 1 is a plan view of a stepping motor in accordance with the first embodiment of the present invention.

As shown in FIG. 1, a stepping motor 200 includes a stator 1 and a rotor 5.

The rotor 5 includes a rotor magnet 50 bipolarly magnetized in its radial direction and a rotary shaft 51 on which the rotor magnet 50 is mounted. In this embodiment, the rotor magnet 50 is substantially cylindrical and the rotary shaft 51 extends through the center of the rotor magnet 50.

Preferred examples of the rotor magnet 50 used include permanent magnets such as rare-earth magnets (a samarium-cobalt magnet, for example), but the magnet used as the rotor magnet 50 is not limited to this kind. Further, although the rotor magnet 50 bipolarly magnetized in its radial direction is used in this embodiment, the rotor magnet 50 may be any other magnet. For example, the rotor magnet 50 may be a magnet quadrupolarly magnetized or a magnet hexapolarly magnetized instead of a magnet bipolarly magnetized. That is, any rotor magnet may be used as long as it is magnetized in the even number (M) of poles.

The rotor 5 is accommodated in a rotor accommodating space 14 of a stator body 10 described below and is rotatable around the rotary shaft 51 as the center of rotation. In this embodiment, the driving pulses are simultaneously or sequentially applied to two coils (the first coil 22a, the second coil 22b) described below, whereby the rotor 5 in the rotor accommodating space 14 is rotatable by a specified step angle in the normal direction (i.e., the clockwise direction) or the reverse direction (i.e., the counterclockwise direction).

The rotary shaft 51 is coupled with, for example, a gear wheel (not shown) constituting a gear-train mechanism that rotates hands of a timepiece, where the rotation of the rotor 5 is designed to rotate the gear wheel.

The rotor magnet 50 in the present embodiment includes rotor-side notches 52 (52a, 52b). Each of the rotor-side notches 52a, 52b is on an outer peripheral surface of the rotor magnet 50 and substantially in the center of the periphery of each of the magnetic poles (the S pole and the N pole).

The rotor-side notches 52 are the rotor-side stoppers that maintain the stationary state of the rotor 5.

In the present embodiment, the stator 1 includes a stator body 10 and two coil blocks 20 (the first coil block 20a, the second coil block 20b). In the following description, the term “coil blocks 20” is used to include both the first coil block 20a and the second coil block 20b.

The stator body 10 includes a substantially T-shaped center yoke 11 and a pair of side yokes 12 (12a, 12b), and has an anchor-like outline. The center yoke 11 includes a straight portion 11a and an arm portion 11b that extends substantially symmetrically from one end of the straight portion 11a. The pair of side yokes 12 (12a, 12b) are disposed at the other end of the straight portion 11a of the center yoke 11, and are substantially symmetrical.

The stator body 10 is made of a highly magnetically permeable materials such as Permalloy.

The stator body 10 has the rotor accommodating space 14, which is a substantially circular hole, at the intersection of the center yoke 11 and the side yokes 12a, 12b. The rotor accommodating space 14 accommodates the rotor 5.

Along the outer periphery of the rotor magnet 50 of the rotor 5 in the rotor accommodating space 14, the stator body 10 in an excited state has three magnetic poles 15 including a first magnetic pole 15a, a second magnetic pole 15b, and a third magnetic pole 15c, disposed every 120 degrees. Although the three magnetic poles 15 are disposed every 120 degrees in this embodiment, this is not limitative in any way. For example, five magnetic poles may be disposed every 72 degrees. That is, the stator body 10 in the excited state may have any number of magnetic poles disposed therein as long as an odd number of magnetic poles are disposed along the outer periphery of the rotor.

In this embodiment, the magnetic pole 15 around the rotor accommodating space 14 and near the center yoke 11 is defined as the first magnetic pole 15a, the magnetic pole 15 around the rotor accommodating space 14 and near the side yoke 12a is defined as the second magnetic pole 15b, and the magnetic pole 15 around the rotor accommodating space 14 and near the side yoke 12b is defined as the third magnetic pole 15c.

With these three magnetic poles 15 (the first magnetic pole 15a, the second magnetic pole 15b, and the third magnetic pole 15c) on the side of the stator 1, their polarities (the S/N pole) are switchable by driving pulses being applied to coils 22 of the two coil blocks 20 described below.

Specifically, one end of the first coil block 20a described below is magnetically coupled with the arm portion 11b of the center yoke 11 of the stator body 10, while the other end of the first coil block 20a is magnetically coupled with a free end of the side yoke 12a of the stator body 10. Similarly, one end of the second coil block 20b is magnetically coupled with the arm portion 11b of the center yoke 11 of the stator body 10, while the other end of the second coil block 20b is magnetically coupled with a free end of the side yoke 12b of the stator body 10.

In this embodiment, driving pulses are applied through a driving pulse supplying circuit 31 described below to the coils 22 (the first coil 22a, the second coil 22b) of these two coil blocks 20 to make the coils 22 generate magnetic flux. The resulting magnetic flux passes through magnetic cores 21 of the coil blocks 20 and the stator body 10 magnetically coupled with the magnetic cores 21, so as to switch the polarity (S/N pole) of the three magnetic poles 15 (the first magnetic pole 15a, the polarities of the second magnetic pole 15b, and the third magnetic pole 15c).

The stator 1 includes stator-side stoppers that maintain the stationary state of the rotor 5. In this embodiment, the stator-side stoppers are a plurality of stator-side notches 16 provided at substantially equal intervals on an inner periphery of the rotor accommodating space 14 of the stator 1. In this embodiment, twelve stator-side notches 16 are provided.

The width of each stator-side notch 16 approximately equals that of the rotor-side notch 52.

The number of the stator-side notches 16 is not limited to twelve. The stator-side notches 16 are preferably arranged on the inner periphery of the rotor accommodating space 14 of the stator 1 at approximately equal intervals. The number of the stator-side notches 16 may be odd or even numbers.

The rotor 5 has stable resting positions (i.e., the positions where the rotor 5 holds this position in a magnetically stable state or the index torque (holding torque) is maximized), the number of which equals the least common multiple of the number of rotor-side notches 52 provided on the rotor magnet 50 and the number of the stator-side notches 16 provided on the stator 1.

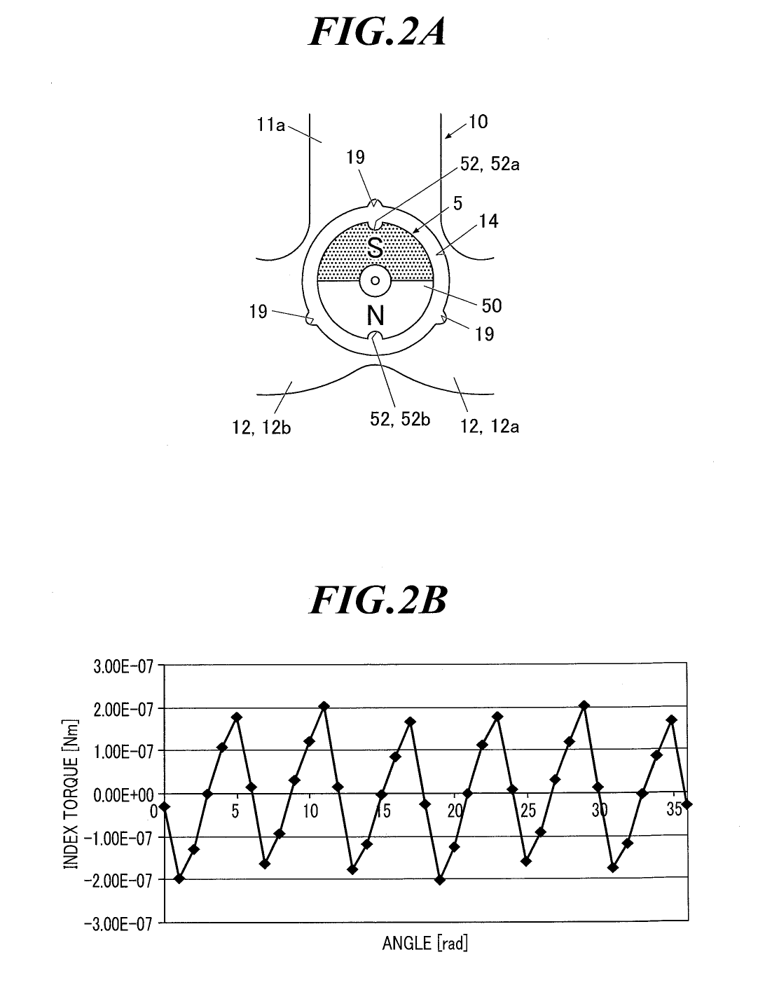

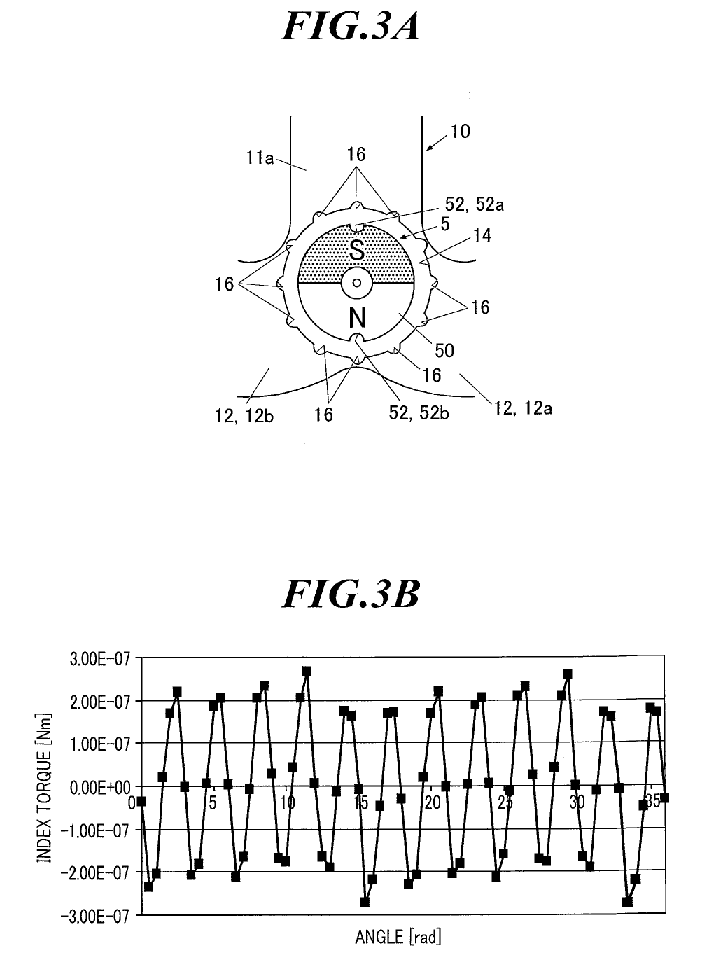

FIG. 2A is an enlarged view of an area around the rotor 5 where three stator-side notches 19 are provided; FIG. 3A is an enlarged view of an area around the rotor 5 where twelve stator-side notches 16 are provided. FIGS. 2B and 3B show results of the index torque (holding torque) peaks simulated with the stepping motors including the stator-side notches and the rotor-side notches shown in FIGS. 2A and 3A, respectively, which are driven with coils 22 having a winding width of 3.0 mm.

For example, in a combination of the rotor magnet 50 provided with two rotor-side notches 52 and the stator 1 provided with three stator-side notches 19 as shown in FIG. 2A, the index torque (holding torque) is maximized at positions where either rotor-side notch 52 faces either stator-side notch 19. As shown in FIG. 2B, the rotor 5 has six stable resting positions.

In contrast, in the present embodiment, the rotor magnet 50 is provided with two rotor-side notches 52 and the stator 1 is provided with twelve stator-side notches 19, as shown in FIG. 3A. In this case, as shown in FIG. 3B, the rotor 5 has twelve stable resting positions where the index torque (holding torque) is maximized.

To achieve the fine rotation angle of the rotor, the required number of index torque (holding torque) peaks is the quotient of 360 degrees divided by the desired rotation angle.

In the example shown in FIGS. 2A and 2B, the rotor 5 can be rotated by a rotation angle of 60 degrees, but cannot be rotated by a smaller angle i.e., a micro-step rotation angle. In the present embodiment having twelve index torque (holding torque) peaks, the rotor 5 can be rotated by a fine rotation angle of 30 degrees.

The peak level of the index torque (holding torque) can be increased by widening or deepening the rotor-side notches 52 and the stator-side notches 19 or by narrowing the air gap between the stator 1 and the rotor magnet 50.

As shown in FIGS. 2A and 2B, when three stator-side notches 19 are provided to produce six peaks of the index torque (holding torque), the pulse width of driving pulses (the length of driving pulses) is 1.5 msec and the pulse rate is 660 pps at maximum required for a rotational torque of 0.20 μNm of the rotor 5 and a sufficient peak level of the index torque. The current consumption required for such a rotational torque is 1.40 μA.

In contrast, as shown in FIGS. 3A and 3B, when twelve stator-side notches 16 are provided to produce twelve peaks of the index torque (holding torque), the pulse width of driving pulses (the length of driving pulses) is 1.0 msec and the pulse rate is 1000 pps at maximum required for a rotational torque of 0.20 μNm of the rotor 5 and a sufficient peak level of the index torque. The current consumption required for such a rotational torque is 1.00 μA. These simulations reveal that when twelve stator-side notches 16 are provided, driving pulses to be applied to the coils 22 can be shorter at reduced power consumption in order to obtain a sufficient peak level of the index torque, as compared to when three stator-side notches 19 are provided.

Although a combination of an increased number of stator-side notches 16 and a reduced step angle of the rotor 5 can provide shorter driving pulses to be applied to the coils 22 at reduced current consumption, a further increase in the number of stator-side notches 16 leads to a significantly instable waveform of the index torque, which causes the risk that the position of the rotor 5 cannot be exactly determined. Under such circumstances, the stepping motor including a compact rotor 5 preferably has a configuration having twelve stator-side notches 16 of the present embodiment, in terms of a stable drive of the motor.

The two coil blocks 20 (the first coil block 20a, the second coil block 20b) each have the magnetic core 21 and the coil 22 (the first coil 22a, the second coil 22b). The magnetic core 21 is made of a highly magnetically permeable material such as Permalloy. A conductive wire is wound around the magnetic core 21, to form the coil 22. In this embodiment, the wire diameter of the conductive wire, the number of windings, and the direction of the windings of the first coil 22a are the same as those of the second coil 22b. In the following description, the term “coils 22” is used to include both the first coil 22a and the second coil 22b.

One end of the magnetic core 21 of the first coil block 20a is magnetically coupled with the arm portion 11b of the center yoke 11 of the stator body 10 by screw fastening; while the other end of the first coil block 20a is magnetically coupled with the free end of the side yoke 12a of the stator body 10 by screw fastening. Similarly, one end of the magnetic core 21 of the second coil block 20b is magnetically coupled with the arm portion 11b of the center yoke 11 of the stator body 10 by screw fastening; while the other end of the second coil block 20b is magnetically coupled with the free end of the side yoke 12b of the stator body 10 by screw fastening.

Any technique other than screw fastening can be employed for magnetic coupling between the stator body 10, the first coil block 20a, and the second coil block 20b. For example, the stator body 10, the first coil block 20a, and the second coil block 20b may be coupled with each other by welding.

The stepping motor 200 may be fixed in any device or substrate not shown in the drawing with screws that fix the stator body 10 and the two coil blocks 20 together.

On the arm portion 11b of the center yoke 11 coupled with the one ends of the magnetic cores 21 of the two coil blocks 20, substrates 17, 18 are overlaid. The substrates 17, 18 are fixed on the stator 1 with screws that fix the stator body 10 and the two coil blocks 20 together. These substrates may be integrated in one piece.

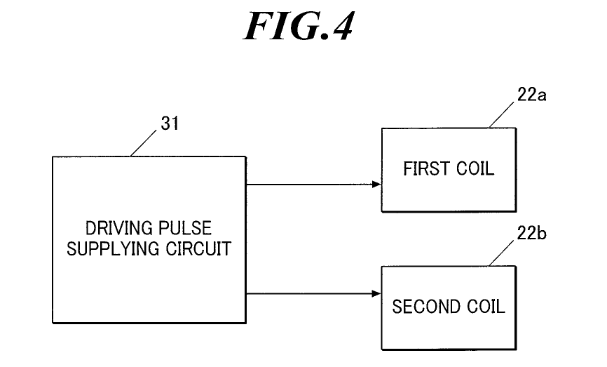

A first coil terminal 171 and a second coil terminal 172 of the first coil block 20a are mounted on the substrate 17. Conductive wire ends 24, 24 of the first coil 22a are connected to the first coil terminal 171 and the second coil terminal 172, respectively, on the substrate 17. The first coil 22a is connected via the first coil terminal 171 and the second coil terminal 172 to the driving pulse supplying circuit 31 described below, as shown in, for example, FIG. 4.

Similarly, a first coil terminal 181 and a second coil terminal 182 of the second coil block 20b are mounted on the substrate 18. Conductive wire ends 24, 24 of the second coil 22b are connected to the first coil terminal 181 and the second coil terminal 182, respectively, on the substrate 18. The second coil 22b is connected via the first coil terminal 181 and the second coil terminal 182 to the driving pulse supplying circuit 31 as shown in, for example, FIG. 4.

FIG. 4 is a schematic block diagram illustrating a mechanism for applying driving pulses to the first coil 22a and the second coil 22b of the stepping motor 200 in accordance with the present embodiment.

In this embodiment, driving pulses are applied from the driving pulse supplying circuit 31 to the first coil 22a and the second coil 22b separately to rotate the rotor 5 by 30 degrees at one time.

In the present embodiment, the rotor accommodating space 14 of the stator 1 is provided on its inner periphery with twelve stator-side notches 16 (the stator-side stoppers) at substantially equal intervals. When each time the rotor 5 comes to a halt at a position where one of the two rotor-side notches 52 (52a, 52b; rotor-side stoppers) provided on the outer periphery of the rotor magnet 50 faces one of the stator-side notches 16, the rotor 5 is rotated 30 degrees. That is, with the stator-side notches 16 (stator-side stoppers) which are formed on the inner periphery of the rotor accommodating space 14 of the stator 1 and the rotor-side notches 52 (52a, 52b; the rotor-side stoppers) which are formed on the outer periphery of the rotor magnet 50, the rotor stoppers are formed at intervals of 30 degrees.

Specifically, driving pulses are applied from the driving pulse supplying circuit 31 to the coils 22 (the first coil 22a, and the second coil 22b) as appropriate such that the rotor 5 rests at a position where either rotor-side notch 52 (52a or 52b) faces one of the stator-side notches 16.

The rotor 5 rotates 30 degrees at a time. Alternatively, the rotor 5 can rotate 60, 120, 180, 240, 300, or 360 degrees at a time by continuously applied driving pulses.

To rotate the bipolarly-magnetized rotor 5 shown in the present embodiment, by applying driving pulses to either or both coils 22, the torque required to rotate the rotor 5 is generated. This embodiment has eight patterns to apply driving pulses (eight application patterns) depending on the combinations of whether or not the driving pulses are applied to each coil 22 and whether those pulses, when applied, are directed in the normal direction or the reverse direction.

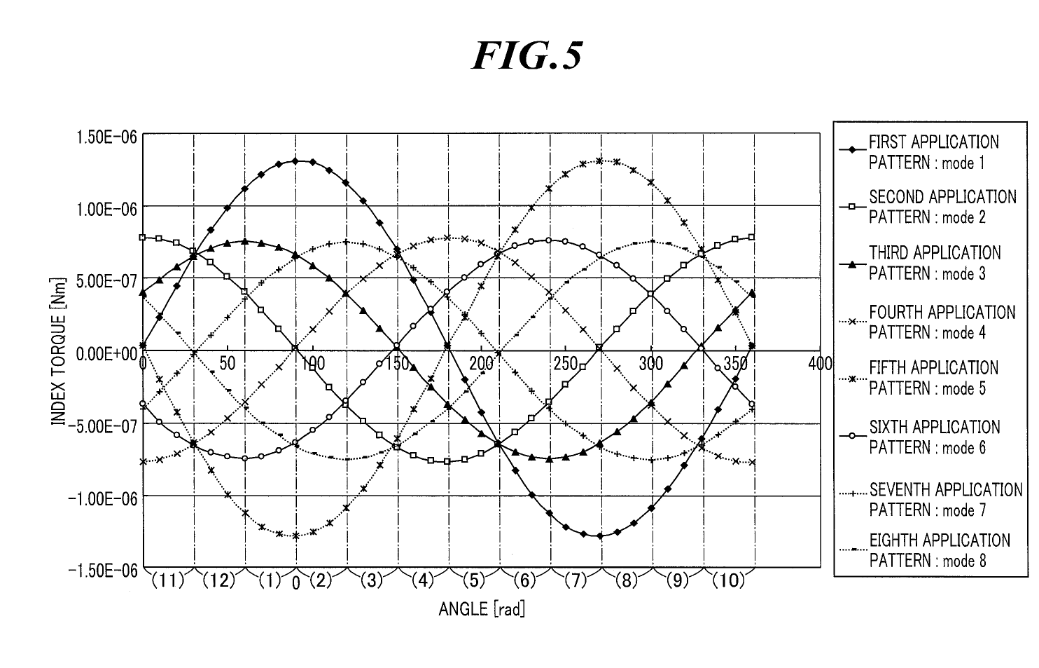

FIG. 5 is a graph showing the torque generated for each of the eight application patterns. The angle [rad] on the horizontal axis of FIG. 5 represents the polarization direction of the rotor magnet 50 (the N/S direction). The left end of FIG. 5 falls on the position of 90 degrees.

In FIG. 5, in the first application pattern (referred to as “mode 1”), 1.0 mA driving pulses are applied to the first coil 22a and the second coil 22b. In the second application pattern (referred to as “mode 2”), 1.0 mA driving pulses are applied to the first coil 22a and −1.0 mA driving pulses are applied to the second coil 22b. In the third application pattern (referred to as “mode 3”), 1.0 mA driving pulses are applied to the first coil 22a only. In the fourth application pattern (referred to as “mode 4”), −1.0 mA driving pulses are applied to the first coil 22a and 1.0 mA driving pulses are applied to the second coil 22b. In the fifth application pattern (referred to as “mode 5”), −1.0 mA driving pulses are applied to the first coil 22a and the second coil 22b. In the sixth application pattern (referred to as “mode 6”), −1.0 mA driving pulses are applied to the first coil 22a only. In the seventh application pattern (referred to as “mode 7”), 1.0 mA driving pulses are applied to the second coil 22b only. In the eighth application pattern (referred to as “mode 8”), −1.0 mA driving pulses are applied to the second coil 22b only.

As shown in FIG. 5, the torque generation pattern depends on the application pattern (mode) of the driving pulses; hence, the application pattern of the driving pulses applied to the coil 22 can be appropriately combined to rotate the rotor 5 by an intended angle.

In this embodiment, as shown in FIG. 5, the application zone of the driving pulses to rotate the rotor 5 by 360 degrees is segmented into twelve “segments” (1) to (12). The driving pulse supplying circuit 31 properly switches the application pattern (mode) of the driving pulses in each segment constantly as appropriate, whereby the rotor 5 is finely rotated in steps of 30 degrees.

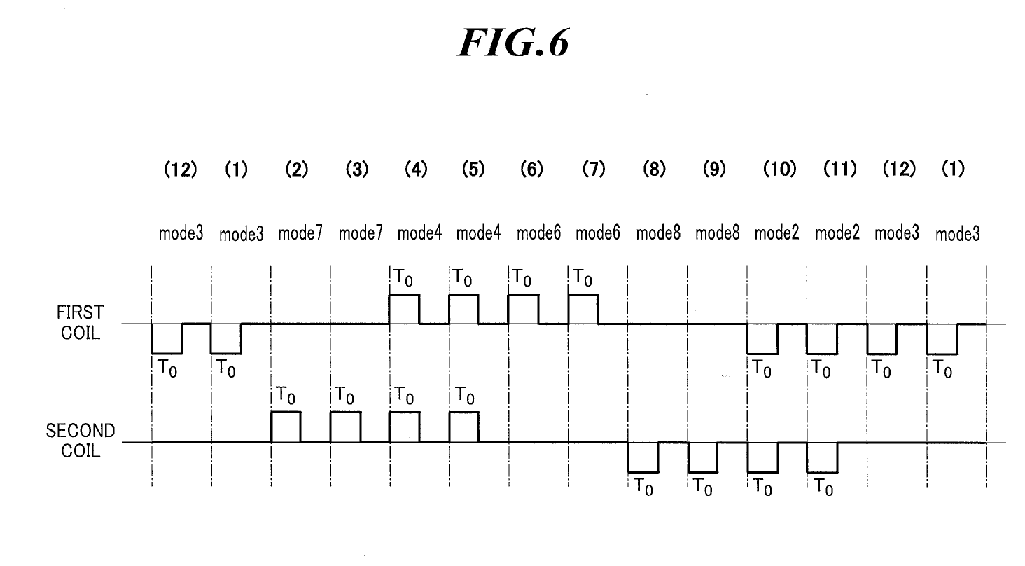

FIG. 6 is a timing chart illustrating the application timing of the driving pulses from the driving pulse supplying circuit 31, and the application pattern (mode) of the driving pulses in each segment in accordance with this embodiment.

The driving pulse supplying circuit 31 maintains a certain width of the pulse applied in each segment of the driving pulses. As shown in FIG. 6, when each segment has a plurality of available application patterns (modes), an application pattern (mode) that applies driving pulses to only one coil 22 is selected, as much as possible.

Combination of such application patterns (modes) simplifies the pulse control by the driving pulse supplying circuit 31 and reduces the control time loss, and increases the number of segments where only one coil 22 is used to rotate the rotor 5, which contributes to power savings.

In a segment in which the application pattern (mode) that applies driving pulses to only one coil 22 is selected, the other coil 22 to which driving pulses are not applied is in a high impedance state. This prevents the other coil 22 from generating reactance that inhibits the rotation of the rotor 5, and therefore reduces the power consumption required to rotate the rotor 5, resulting in further power savings.

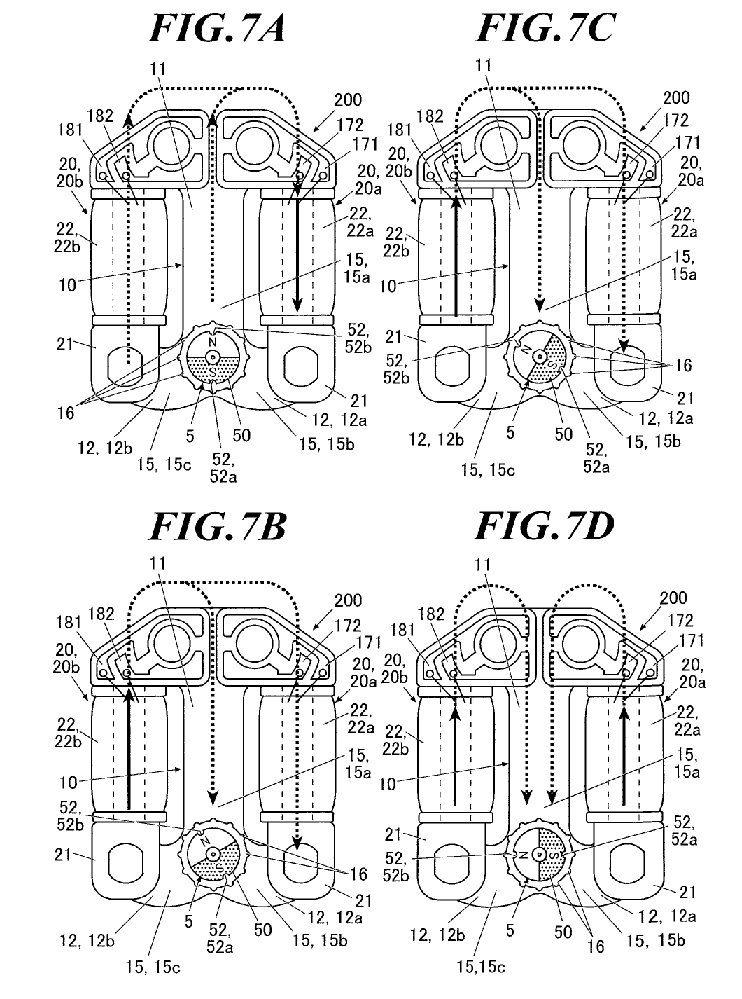

The operation of the stepping motor 200 in accordance with the present embodiment will now be described with reference to FIG. 6, FIGS. 7A to 7D, FIGS. 8A to 8D and FIGS. 9A to 9D. In FIGS. 7A to 7D, FIGS. 8A to 8D and FIGS. 9A to 9D, solid arrows indicate the direction of magnetic flux caused by the coil 22 to which driving pulses are applied; dashed arrows indicate the flow of the magnetic flux through the stator 1.

In FIG. 7(1), one rotor-side notch 52a of the rotor magnet 50 faces one stator-side notch 16 located substantially in the lateral center of the center yoke 11, while the other rotor-side notch 52b of the rotor magnet 50 faces another stator-side notch 16 located at the radially opposed position of the first stator-side notch 16 in the radial direction of the rotor 5. Such a position is referred to as an “initial position.” (In other words, in the initial position, the N pole of the rotor magnet 50 is in the most proximate position to the first magnetic pole 15a, as apparent from FIG. 7(1).) In such a position, the rotor 5 is in a magnetically stable resting condition. This condition is referred to as an “initial condition.”

In this embodiment, in the segments (1) to (12), the driving pulse supplying circuit 31 applies driving pulses to the coil 22 in different application patterns (modes) selected for each of the segments (1) to (12). This causes the rotor 5 to rotate 360 degrees in steps of 30 degrees counterclockwise (in the reverse direction) from the initial position.

In the first stage, the rotor 5 is in the initial position shown in FIG. 7A. As shown in FIG. 6, the driving pulse supplying circuit 31 selects “mode 3” among the eight application patterns in the segment (1) and applies 1.0 mA driving pulse with a pulse width T₀ to the first coil 22a. This pulse generates a magnetic flux in the direction indicated by the solid arrow in FIG. 7A in the first coil 22a, whereby the rotor 5 starts its counterclockwise rotation. After the rotor 5 rotates 30 degrees counterclockwise from the initial position as shown in FIG. 7B, the rotor-side notches 52a, 52b face the respective stator-side notches 16. The rotor 5 holds this position in a magnetically stable state.

In the second stage, the driving pulse supplying circuit 31 selects “mode 7” in the segment (2) and applies 1.0 mA driving pulse with a pulse width T₀ to the second coil 22b. This pulse generates a magnetic flux in the direction indicated by the solid arrow in FIG. 7B in the second coil 22b, whereby the rotor 5 rotates further 30 degrees counterclockwise. After the rotor 5 rotates 60 degrees counterclockwise from the initial position as shown in FIG. 7C, the rotor-side notches 52a, 52b face the respective stator-side notches 16. The rotor 5 holds this position in a magnetically stable state.

In the third stage, the driving pulse supplying circuit 31 selects “mode 7” in the segment (3) and applies 1.0 mA driving pulse with a pulse width T₀ to the second coil 22b. This pulse generates a magnetic flux in the direction indicated by the solid arrow in FIG. 7C in the second coil 22b, whereby the rotor 5 rotates further 30 degrees counterclockwise. After the rotor 5 rotates 90 degrees counterclockwise from the initial position as shown in FIG. 7D, the rotor-side notches 52a, 52b face the respective stator-side notches 16. The rotor 5 holds this position in a magnetically stable state.

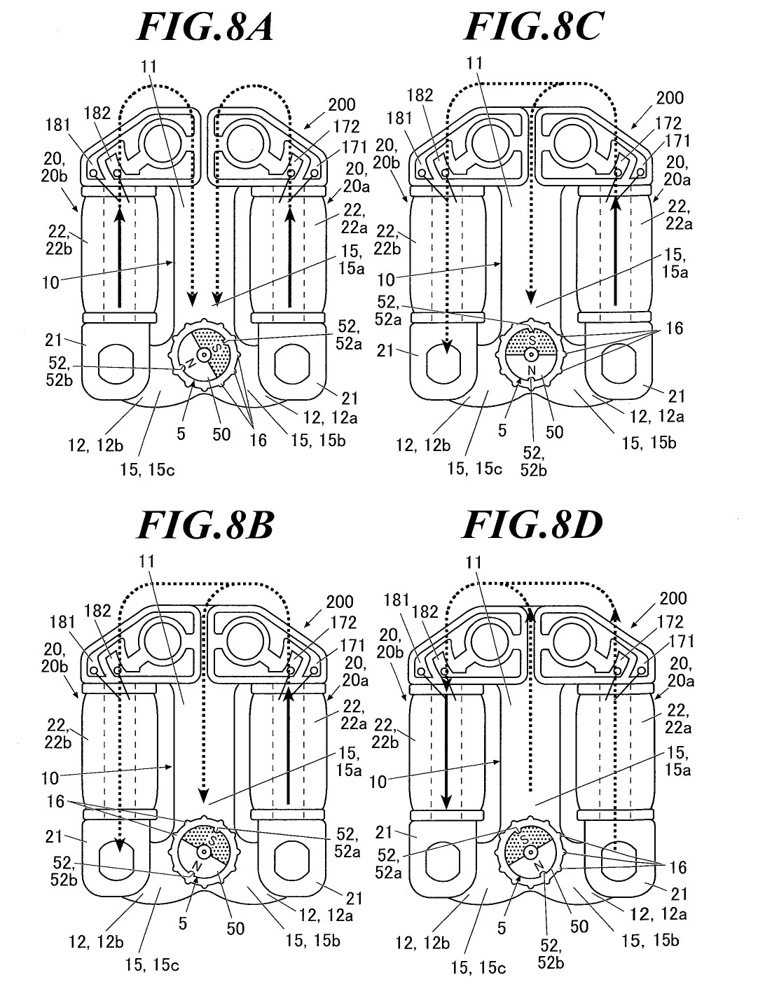

In the next stage, the driving pulse supplying circuit 31 selects “mode 4” in the segment (4) pulses and applies −1.0 mA driving pulse with a pulse width T₀ to the first coil 22a and 1.0 mA driving pulse with a pulse width T₀ to the second coil 22b. These pulses generate magnetic fluxes in the direction indicated by the solid arrows in FIG. 7D in the first coil 22a and the second coil 22b, respectively, whereby the rotor 5 rotates further 30 degrees counterclockwise. After the rotor 5 rotates 120 degrees counterclockwise from the initial position as shown in FIG. 8A, the rotor-side notches 52a, 52b face the respective stator-side notches 16. The rotor 5 holds this position in a magnetically stable state.

In the next stage, the driving pulse supplying circuit 31 selects “mode 4” in the segment (5) and applies −1.0 mA driving pulse with a pulse width T₀ to the first coil 22a and 1.0 mA driving pulse with a pulse width T₀ to the second coil 22b. These pulses generate magnetic fluxes in the direction indicated by the solid arrows in FIG. 8A in the first coil 22a and the second coil 22b, respectively, whereby the rotor 5 rotates further 30 degrees counterclockwise. After the rotor 5 rotates 150 degrees counterclockwise from the initial position as shown in FIG. 8B, the rotor-side notches 52a, 52b face the respective stator-side notches 16. The rotor 5 holds this position in a magnetically stable state.

In the next stage, the driving pulse supplying circuit 31 selects “mode 6” in the segment (6) and applies −1.0 mA driving pulse with a pulse width T₀ to the first coil 22a. This pulse generates a magnetic flux in the direction indicated by the solid arrow in FIG. 8B in the first coil 22a, whereby the rotor 5 rotates further 30 degrees counterclockwise. After the rotor 5 rotates 180 degrees from the initial position as shown in FIG. 8C, the rotor-side notches 52a, 52b face the respective stator-side notches 16. The rotor 5 holds this position in a magnetically stable state.

In the next stage, the driving pulse supplying circuit 31 selects “mode 6” in the segment (7) and applies −1.0 mA driving pulse with a pulse width T₀ to the first coil 22a. This pulse generates a magnetic flux in the direction indicated by the solid arrow in FIG. 8C in the first coil 22a, whereby the rotor 5 rotates further 30 degrees counterclockwise. After the rotor 5 rotates 210 degrees from the initial position as shown in FIG. 8D, the rotor-side notches 52a, 52b face the respective stator-side notches 16. The rotor 5 holds this position in a magnetically stable state.

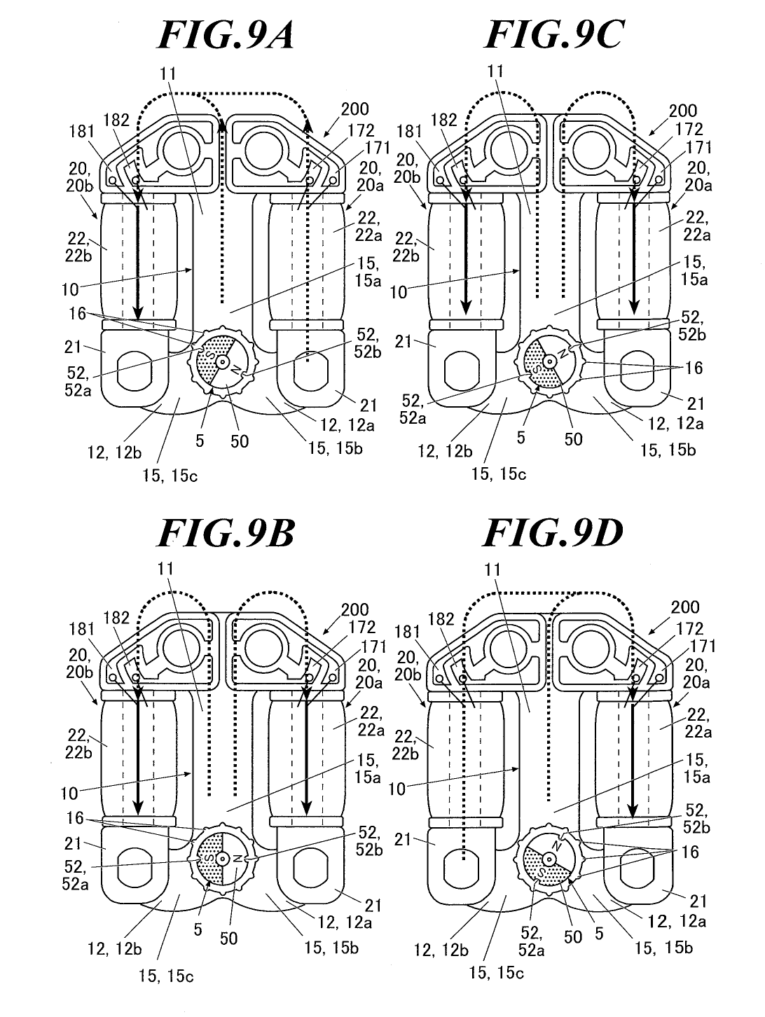

In the next stage, the driving pulse supplying circuit 31 selects “mode 8” in the segment (8) and applies −1.0 mA driving pulse with a pulse width T₀ to the second coil 22b. This pulse generates a magnetic flux in the direction indicated by the solid arrow in FIG. 8D in the second coil 22b, whereby the rotor 5 rotates further 30 degrees counterclockwise. After the rotor 5 rotates 240 degrees from the initial position as shown in FIG. 9A, the rotor-side notches 52a, 52b face the respective stator-side notches 16. The rotor 5 holds this position in a magnetically stable state.

In the next stage, the driving pulse supplying circuit 31 selects “mode 8” in the segment (9) and applies −1.0 mA driving pulse with a pulse width T₀ to the second coil 22b. This pulse generates a magnetic flux in the direction indicated by the solid arrow in FIG. 9A in the second coil 22b, whereby the rotor 5 rotates further 30 degrees counterclockwise. After the rotor 5 rotates 270 degrees from the initial position as shown in FIG. 9B, the rotor-side notches 52a, 52b face the respective stator-side notches 16. The rotor 5 holds this position in a magnetically stable state.

In the next stage, the driving pulse supplying circuit 31 selects “mode 2” in the segment (10) and applies 1.0 mA driving pulse with a pulse width T₀ to the first coil 22a and −1.0 mA driving pulse with a pulse width T₀ to the second coil 22b. These pulses generate magnetic fluxes in the direction indicated by the solid arrows in FIG. 9B in the first coil 22a and the second coil 22b, respectively, whereby the rotor 5 rotates further 30 degrees counterclockwise. After the rotor 5 rotates 300 degrees from the initial position as shown in FIG. 9C, the rotor-side notches 52a, 52b face the respective stator-side notches 16. The rotor 5 holds this position in a magnetically stable state.

In the next stage, the driving pulse supplying circuit 31 selects “mode 2” in the segment (11) and applies 1.0 mA driving pulse with a pulse width T₀ to the first coil 22a and −1.0 mA driving pulse with a pulse width T₀ to the second coil 22b. These pulses generate magnetic fluxes in the direction indicated by the solid arrows in FIG. 9C in the first coil 22a and the second coil 22b, respectively, whereby the rotor 5 rotates further 30 degrees counterclockwise. After the rotor 5 rotates 330 degrees from the initial position as shown in FIG. 9D, the rotor-side notches 52a, 52b face the respective stator-side notches 16. The rotor 5 holds this position in a magnetically stable state.

In the next stage, the driving pulse supplying circuit 31 selects “mode 3” in the segment (12) and applies 1.0 mA driving pulse with a pulse width T₀ to the first coil 22a. This pulse generates a magnetic flux in the direction indicated by the solid arrow in FIG. 9D in the first coil 22a, whereby the rotor 5 rotates further 30 degrees counterclockwise to return to the initial position shown in FIG. 7A. The rotor 5 holds this position in a magnetically stable state.

The above description focuses on the rotor 5 rotating counterclockwise (in the reverse direction). This embodiment may also be applied to the rotor 5 rotating clockwise (in the normal direction). Also in the normal direction, the driving pulse supplying circuit 31 properly selects the application pattern (mode) of driving pulses in each segment and applies a certain driving pulse to the coil 22 in the selected mode, as in the reverse direction. Such an operation leads to a clockwise rotation (rotation in the normal direction) of the rotor 5 by 360 degrees.

As described above, according to the present embodiment, in the stepping motor 200 including two coils 22, rotor-side notches 52a, 52b are provided at the tops of the magnetic poles of the rotor magnet 50 and stator-side notches 16 are provided at the stator 1 at substantially equal intervals. The width of each stator-side notch 16 is substantially equal to that of the rotor-side notches 52a, 52b. The rotor-side notches 52a, 52b faces the respective stator-side notch 16, where the rotor 5 holds this position in a magnetically stable state.

The number of peaks of the index torque (holding torque), at which the rotor 5 holds this position in a magnetically stable state, is the least common multiple of the number of rotor-side notches 52 and the number of the stator-side notches 16. In this embodiment, two rotor-side notches 52 and twelve stator-side notches 16 are disposed, which indicates that twelve peaks of the index torque (holding torque) are produced. This allows a precise and fine rotation of the rotor 5 in steps of 30 degrees.

The resulting stepping motor 200 can produce sufficient rotational torque with reduced current consumption, and therefore achieves the power savings.

The rotor magnet 50 of the rotor 5 rotatable at such a fine rotation angle is made of a cylindrical magnet bipolarly magnetized in its radial direction. The rotor magnet 50 can therefore be produced without complicated expensive molds or magnetizers at reduced costs.

The rotor magnet 50 in this embodiment is a cylindrical magnet with notches (recesses), which has a simple shape and can be significantly miniaturized. Such a rotor magnet 50 can be incorporated in the stepping motor 200 used as a power source of compact devices, leading to a successful dimensional reduction in the entire motor.

In this embodiment, the driving pulse supplying circuit 31 applies the driving pulses with a constant pulse width to the coils 22 in each of the segments (1) to (12). This configuration allows the simple control and stable driving.

### Second Embodiment

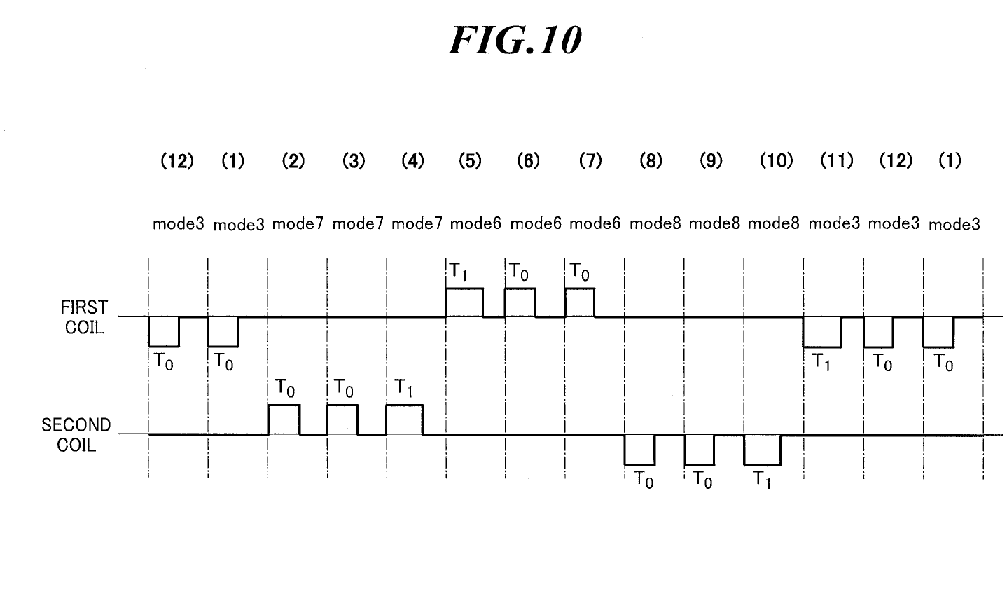

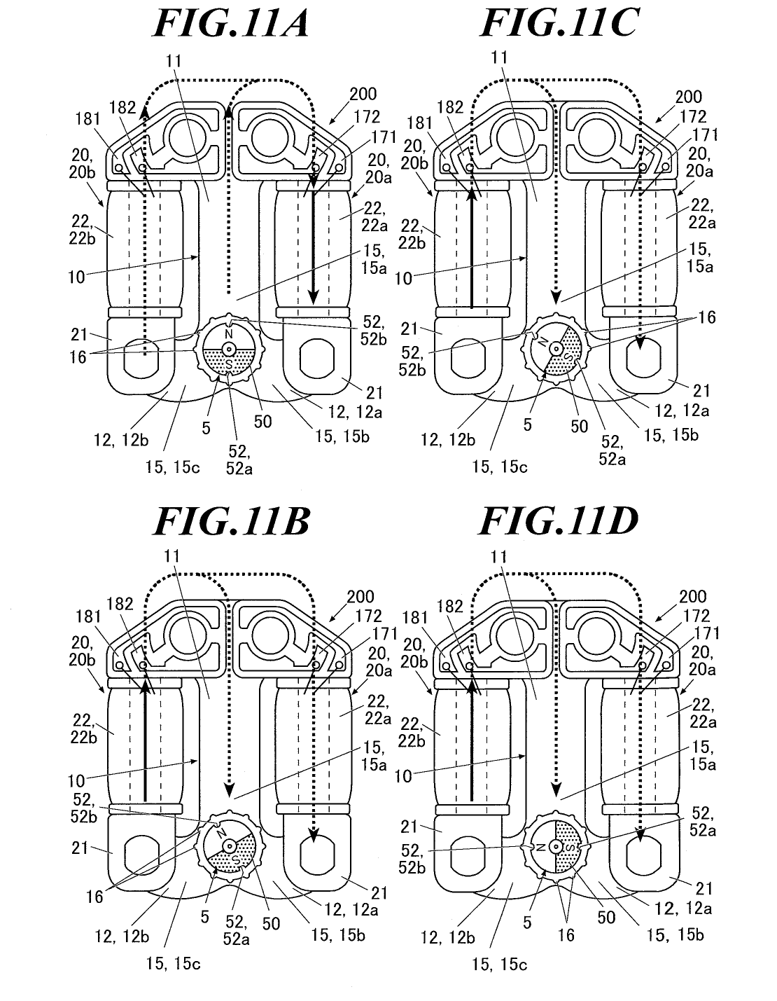

With reference to FIG. 10, FIGS. 11A to 11D, FIGS. 12A to 12D and FIGS. 13A to 13D, a stepping motor will now be described in accordance with a second embodiment of the present invention. This embodiment differs from the first embodiment in the way of applying the driving pulses from the driving pulse supplying circuit 31, and therefore only such a difference will be described below.

FIG. 10 is a timing chart illustrating the application of the driving pulses from the driving pulse supplying circuit 31, and the application pattern (mode) of the driving pulses in each segment in accordance with this embodiment.

As shown in FIG. 10, the width of the pulse applied in each segment of the driving pulses from the driving pulse supplying circuit 31 can be appropriately varied. In all segments of the driving pulses, an application pattern (mode) is selected to apply driving pulses to only one coil 22.

Combination of application patterns (modes) to rotate the rotor 5 with one of the coils 22 contributes to further power savings.

Such an application of driving pulses to one coil 22 puts the other coil 22 with no driving pulses applied into a high impedance state. This prevents the other coil 22 from generating the reactance that would obstruct the rotation of the rotor 5. As a result, power consumption required to rotate the rotor 5 is reduced, resulting in further power savings.

The other components are identical to those in the first embodiment and thus are referred to by the same reference signs without redundant description.

The operation of the stepping motor 200 in accordance with the present embodiment will now be described with reference to FIG. 10, FIGS. 11A to 11D, FIGS. 12A to 12D and FIGS. 13A to 13D. In FIGS. 11A to 11D, FIGS. 12A to 12D and FIGS. 13A to 13D, solid arrows indicate the direction of magnetic flux caused by the coil 22 to which driving pulses are applied; dashed arrows indicate the flow of the magnetic flux through the stator 1.

The following explanation will focus on an example stepping motor 200 in accordance with the second embodiment in which the rotor 5 is rotated 360 degrees counterclockwise (in the reverse direction) from an initial position shown in FIG. 11A in steps of 30 degrees, as in the first embodiment.

In the first stage, the rotor 5 is in the initial position shown in FIG. 11A. As shown in FIG. 10, the driving pulse supplying circuit 31 selects “mode 3” in the segment (1) and applies 1.0 mA driving pulse with a pulse width T₀ (for example, 0.7 msec, hereinafter “T₀” has the same value) to the first coil 22a. This causes the rotor 5 to start its rotation counterclockwise. After the rotor 5 rotates 30 degrees counterclockwise from the initial position as shown in FIG. 11B, rotor-side notches 52a, 52b face the respective stator-side notches 16. The rotor 5 holds this position in a magnetically stable state.

In the second stage, the driving pulse supplying circuit 31 selects “mode 7” in the segment (2) and applies 1.0 mA driving pulse with a pulse width T₀ to the second coil 22b. This pulse causes the rotor 5 to rotate further 30 degrees counterclockwise. After the rotor 5 rotates 60 degrees from the initial position as shown in FIG. 11C, the rotor-side notches 52a, 52b face the respective stator-side notches 16. The rotor 5 holds this position in a magnetically stable state.

In the third stage, the driving pulse supplying circuit 31 selects “mode 7” in the segment (3) and applies 1.0 mA driving pulse with a pulse width T₀ to the second coil 22b. This causes the rotor 5 to rotate further 30 degrees counterclockwise. After the rotor 5 rotates 90 degrees from the initial position shown in FIG. 11D, the rotor-side notches 52a, 52b face the respective stator-side notches 16. The rotor 5 holds this position in a magnetically stable state.

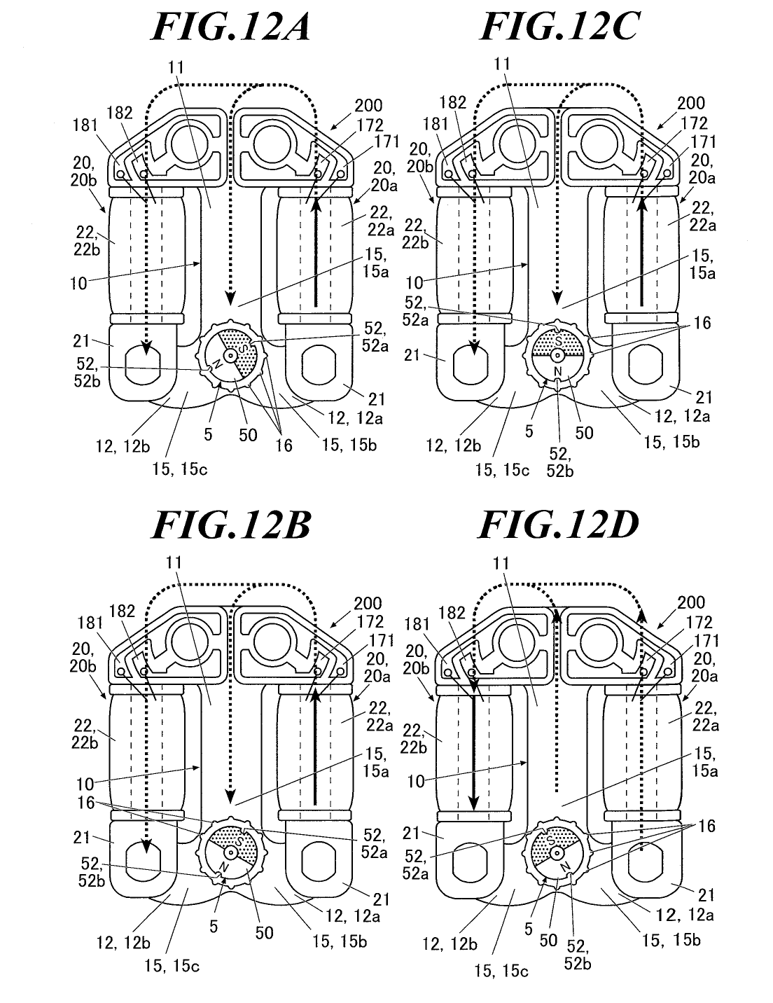

In the next stage, the driving pulse supplying circuit 31 selects “mode 7” in the segment (4), although the torque in the segment (4) is low as compared to that in the segments (2) and (3). The driving pulse supplying circuit 31 applies 1.0 mA driving pulse with a pulse width T₁ (for example, 1.0 msec, hereinafter “T₁” has the same value) to the second coil 22b. The pulse width T₁ is longer than T₀. This pulse causes the rotor to rotate further 30 degrees counterclockwise. After the rotor 5 rotates 120 degrees from the initial position as shown in FIG. 12A, the rotor-side notches 52a, 52b faces the respective stator-side notches 16. The rotor 5 holds this position in a magnetically stable state.

In the next stage, the driving pulse supplying circuit 31 selects “mode 6” in the segment (5), although the torque in the segment (5) is low as compared to that in the segments (6) and (7). The driving pulse supplying circuit 31 applies −1.0 mA driving pulse with a pulse width T₁ to the first coil 22a. This pulse causes the rotor 5 to rotate further 30 degrees counterclockwise. After the rotor 5 rotates 150 degrees from the initial position as shown in FIG. 12B, the rotor-side notches 52a, 52b face the respective stator-side notches 16. The rotor 5 holds this position in a magnetically stable state.

In the next stage, the driving pulse supplying circuit 31 selects “mode 6” in the segment (6) and applies −1.0 mA driving pulse with a pulse width T₀ to the first coil 22a. This pulse causes the rotor 5 to rotate further 30 degrees counterclockwise. After the rotor 5 rotates 180 degrees from the initial position as shown in FIG. 12C, the rotor-side notches 52a, 52b face the respective stator-side notches 16. The rotor 5 holds this position in a magnetically stable state.

In the next stage, the driving pulse supplying circuit 31 selects “mode 6” in the segment (7) and applies −1.0 mA driving pulse with a pulse width T₀ to the first coil 22a. This pulse causes the rotor 5 to rotate further 30 degrees counterclockwise. After the rotor rotates 210 degrees from the initial position as shown in FIG. 12D, the rotor-side notches 52a, 52b face the respective stator-side notches 16. The rotor 5 holds this position in a magnetically stable state.

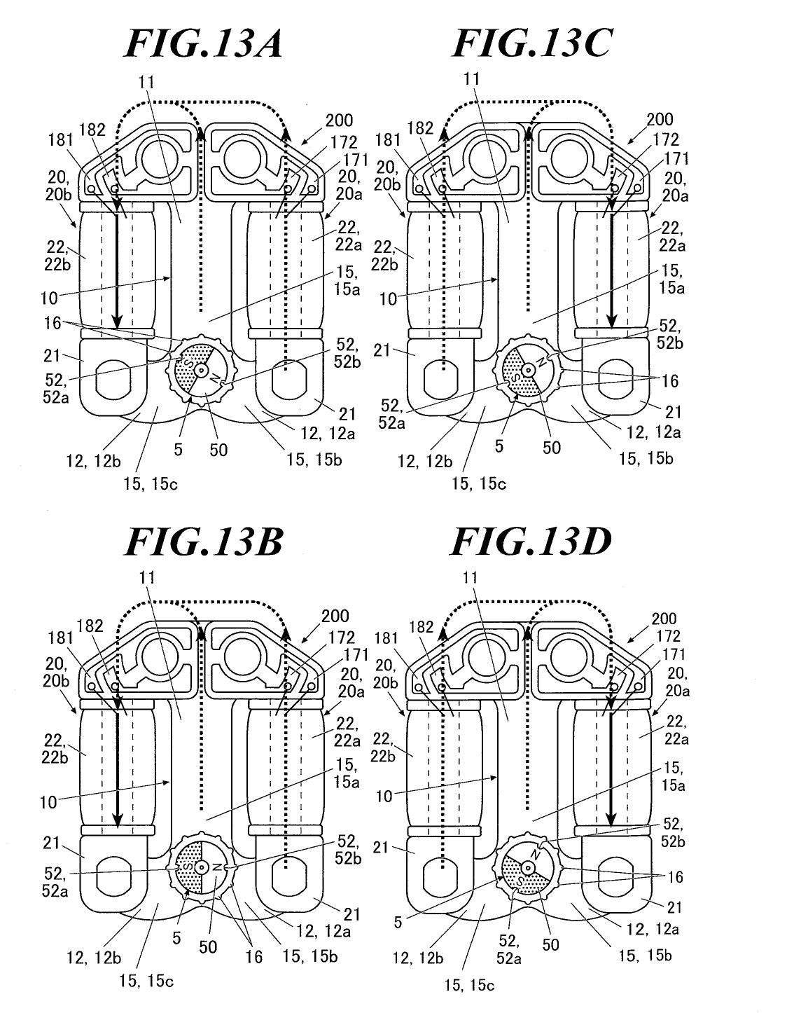

In the next stage, the driving pulse supplying circuit 31 selects “mode 8” in the segment (8) and applies −1.0 mA driving pulse with a pulse width T₀ to the second coil 22b. This pulse causes the rotor 5 to rotate further 30 degrees counterclockwise. After the rotor 5 rotates 240 degrees from the initial position as shown in FIG. 13A, the rotor-side notches 52a, 52b face the respective stator-side notches 16. The rotor 5 holds this position in a magnetically stable state.

In the next stage, the driving pulse supplying circuit 31 selects “mode 8” in the segment (9) and applies −1.0 mA driving pulse with a pulse width T₀ to the second coil 22b. This pulse causes the rotor 5 to rotate further 30 degrees counterclockwise. After the rotor rotates 270 degrees from the initial position as shown in FIG. 13B, the rotor-side notches 52a, 52b face the respective stator-side notches 16. The rotor 5 holds this position in a magnetically stable state.

In the next stage, the driving pulse supplying circuit 31 selects “mode 8” in the segment (10), although the torque in the segment (10) is low as compared to that in the segments (8) and (9). The driving pulse supplying circuit 31 applies −1.0 mA driving pulse with a pulse width T₁ to the second coil 22b. This pulse causes the rotor 5 to rotate further 30 degrees counterclockwise. After the rotor 5 rotates 300 degrees from the initial position as shown in FIG. 13C, the rotor-side notches 52a, 52b face the respective stator-side notches 16. The rotor 5 holds this position in a magnetically stable state.

In the next stage, the driving pulse supplying circuit 31 selects “mode 3” in the segment (11), although the torque in the segment (11) is low as compared to that in the segments (12) and (1). The driving pulse supplying circuit 31 applies 1.0 mA driving pulse with a pulse width T₁ to the first coil 22a. This pulse causes the rotor 5 to rotate further 30 degrees counterclockwise. After the rotor 5 rotates 330 degrees from the initial position as shown in FIG. 13D, the rotor-side notches 52a, 52b face the respective stator-side notches 16. The rotor 5 holds this position in a magnetically stable state.

In the next stage, the driving pulse supplying circuit 31 selects “mode 3” in the segment (12) and applies 1.0 mA driving pulse with a pulse width T₀ to the first coil 22a. This pulse causes the rotor 5 to rotate further 30 degrees counterclockwise and return to the initial position as shown in FIG. 11A. The rotor 5 holds this position in a magnetically stable state.

As in the case of the first embodiment, the rotor in the present embodiment may be rotated 360 degrees clockwise (in the normal direction). To achieve such a clockwise rotation, the driving pulse supplying circuit 31 properly selects the application pattern (mode) of driving pulses in each segment and applies a driving pulse to the coils 22 in the mode selected.

The lengths of T₀ and T₁ (the pulse widths) indicated above are exemplary; they can have other suitable values provided that the relationship “T₀<T₁” holds true.

In the second embodiment, the driving pulse supplying circuit 31 modifies the pulse width of the driving pulses. Alternatively, it may modify the amperage of the driving pulses. For example, an application of 1.0 mA driving pulse with a pulse width T₀ and an application of 1.5 mA driving pulse with a pulse width T₀ may be used.

The other operations are identical to those in the first embodiment and the redundant description thereof is omitted.

As described above, the second embodiment can provide the same advantageous effects as the first embodiment and additional advantageous effects below.

The driving pulse supplying circuit 31 in accordance with the present embodiment applies driving pulses to only one coil 22 in all segments (1) to (12) to rotate the rotor 5. This allows the driving of the rotor 5 with reduced power consumption.

### Third Embodiment

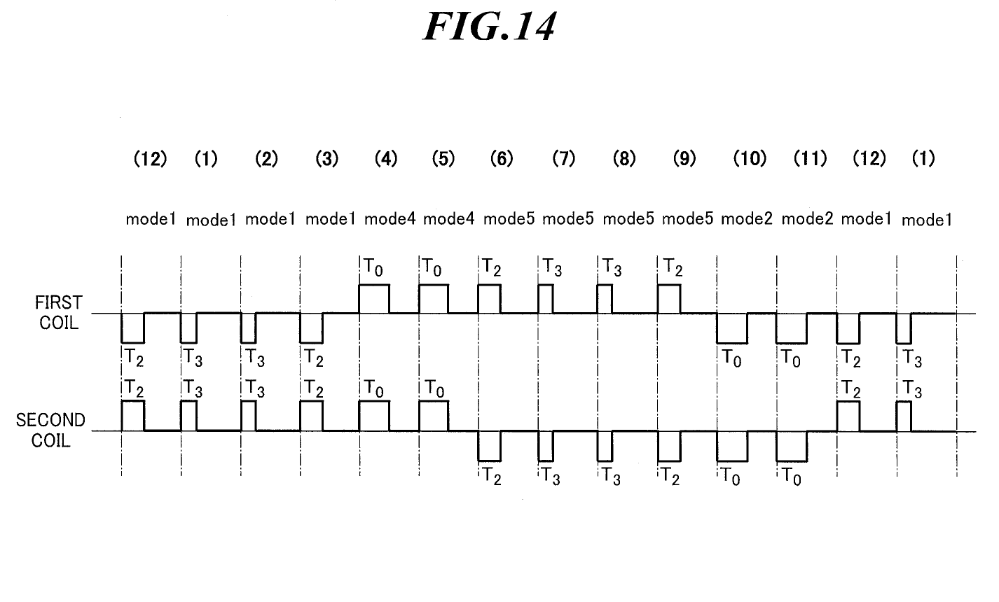

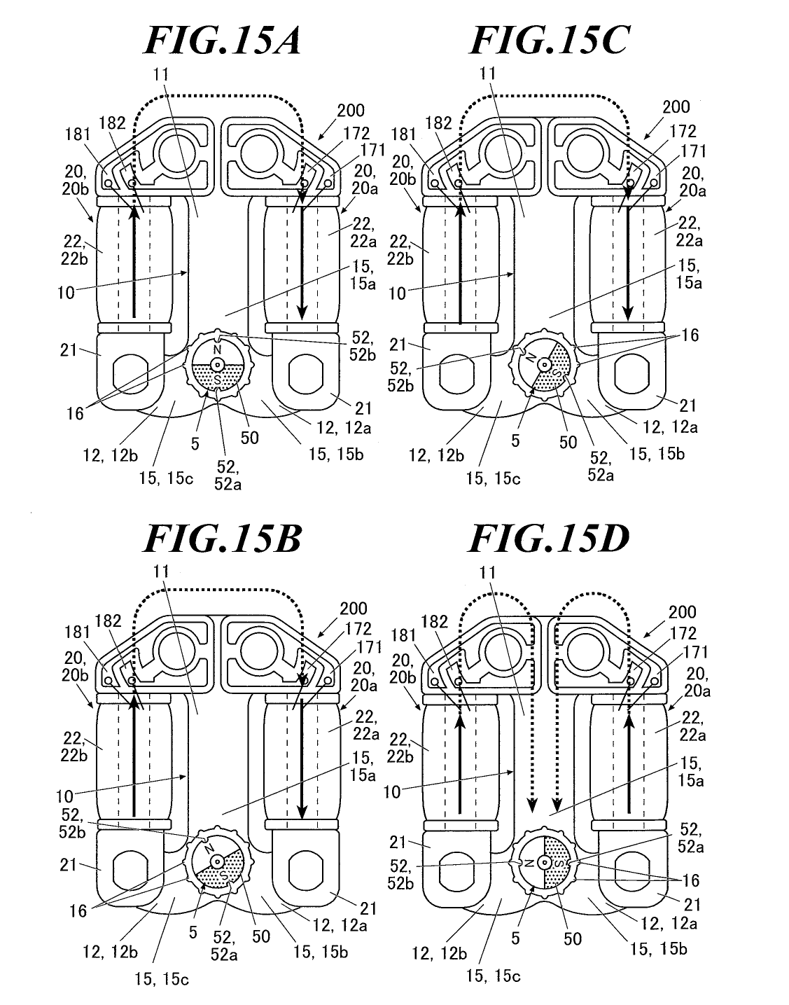

With reference to FIG. 14, FIGS. 15A to 15D, FIGS. 16A to 16D and FIGS. 17A to 17D, a stepping motor will now be described in accordance with a third embodiment of the present invention. This embodiment differs from the first embodiment in the way of applying the driving pulses from the driving pulse supplying circuit 31, and therefore only such differences will be described below.

FIG. 14 is a timing chart illustrating the application of the driving pulses from the driving pulse supplying circuit 31, and the application pattern (mode) of the driving pulses in each segment in accordance with this embodiment.

As shown in FIG. 14, the width of the pulse applied in each segment of the driving pulses from the driving pulse supplying circuit 31 can be appropriately varied. In all segments, an application pattern (mode) is selected to apply driving pulses to both coils 22.

Combination of such application patterns (modes) maximizes the rotation torque of the rotor 5, which achieves the driving of the rotor 5 at high speed.

The other components are identical to those in the first embodiment and thus are referred to by the same reference signs without redundant description.

The operation of the stepping motor 200 in accordance with the present embodiment will now be described with reference to FIG. 14, FIGS. 15A to 15D, FIGS. 16A to 16D and FIGS. 17A to 17D. In FIGS. 15A to 15D, FIGS. 16A to 16D and FIGS. 17A to 17D, solid arrows indicate the direction of magnetic flux caused by the coils 22 to which driving pulses are applied; dashed arrows indicate the flow of the magnetic flux through the stator 1.

The following description will focus on an example stepping motor 200 in accordance with the third embodiment in which the rotor 5 is rotated 360 degrees counterclockwise (in the reverse direction) from an initial position shown in FIG. 15A in steps of 30 degrees, as in the case of the first embodiment.

In the first stage, the rotor 5 is in the initial position shown in FIG. 15A. As shown in FIG. 14, the driving pulse supplying circuit 31 selects “mode 1” in the segment (1) and applies 1.0 mA driving pulse with a pulse width T₃ (for example, 0.3 msec, hereinafter “T₃” has the same value) to the first coil 22a and 1.0 mA driving pulse with a pulse width T₃ to the second coil 22b. This causes the rotor 5 to start its rotation counterclockwise. After the rotor 5 rotates 30 degrees counterclockwise from the initial position as shown in FIG. 15B, rotor-side notches 52a, 52b face the respective stator-side notches 16. The rotor 5 holds this position in a magnetically stable state.

In the next stage, the driving pulse supplying circuit 31 selects “mode 1” in the segment (2) and applies 1.0 mA driving pulse with a pulse width T₃ to the first coil 22a and 1.0 mA driving pulse with a pulse width T₃ to the second coil 22b. This causes the rotor 5 to rotate further 30 degrees counterclockwise. After, the rotor 5 rotates 60 degrees from the initial position as shown in FIG. 15C, the rotor-side notches 52a, 52b face the respective stator-side notches 16. The rotor 5 holds this position in a magnetically stable state.

In the third stage, the driving pulse supplying circuit 31 selects “mode 1” in the segment (3) and applies 1.0 mA driving pulse with a pulse width T₂ (for example, 0.5 msec, hereinafter “T₂” has the same value) to the first coil 22a and 1.0 mA driving pulse with a pulse width T₂ to the second coil 22b. This causes the rotor 5 to rotate further 30 degrees counterclockwise.

After the rotor 5 rotates 90 degrees from the initial position as shown in FIG. 15D, the rotor-side notches 52a, 52b face the respective stator-side notches 16. The rotor 5 holds this position in a magnetically stable state.

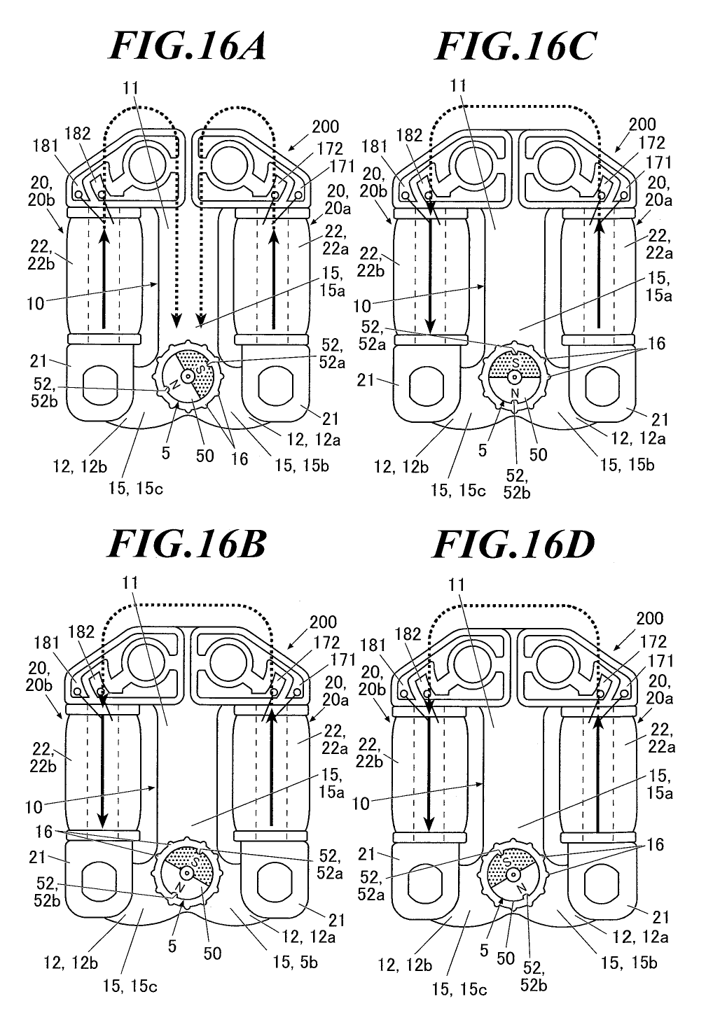

In the next stage, the driving pulse supplying circuit 31 selects “mode 4” in the segment (4) and applies −1.0 mA driving pulse with a pulse width T₀ to the first coil 22a and 1.0 mA driving pulse with a pulse width T₀ to the second coil 22b. This causes the rotor 5 to rotate further 30 degrees counterclockwise. After the rotor 5 rotates 120 degrees from the initial position as shown in FIG. 16A, the rotor-side notches 52a, 52b face the respective stator-side notches 16. The rotor 5 holds this position in a magnetically stable state.

In the next stage, the driving pulse supplying circuit 31 selects “mode 4” in the segment (5) and applies −1.0 mA driving pulse with a pulse width T₀ to the first coil 22a and 1.0 mA driving pulse with a pulse width T₀ to the second coil 22b. This causes the rotor 5 to rotate further 30 degrees counterclockwise. After the rotor 5 rotates 150 degrees from the initial position as shown in FIG. 16B, the rotor-side notches 52a, 52b face the respective stator-side notches 16. The rotor 5 holds this position in a magnetically stable state.

In the next stage, the driving pulse supplying circuit 31 selects “mode 5” in the segment (6) and applies −1.0 mA driving pulse with a pulse width T₂ to the first coil 22a and −1.0 mA driving pulse with a pulse width T₂ to the second coil 22b. This causes the rotor 5 to rotate further 30 degrees counterclockwise. After the rotor 5 rotates 180 degrees from the initial position as shown in FIG. 16C, the rotor-side notches 52a, 52b face the respective stator-side notches 16. The rotor 5 holds this position in a magnetically stable state.

In the next stage, the driving pulse supplying circuit 31 selects “mode 5” in the segment (7) and applies −1.0 mA driving pulse with a pulse width T₃ to the first coil 22a and −1.0 mA driving pulse with a pulse width T₃ to the second coil 22b. This causes the rotor 5 to rotate further 30 degrees counterclockwise. After the rotor 5 rotates 210 degrees from the initial position as shown in FIG. 16D, the rotor-side notches 52a, 52b face the respective stator-side notches 16. The rotor 5 holds this position in a magnetically stable state.

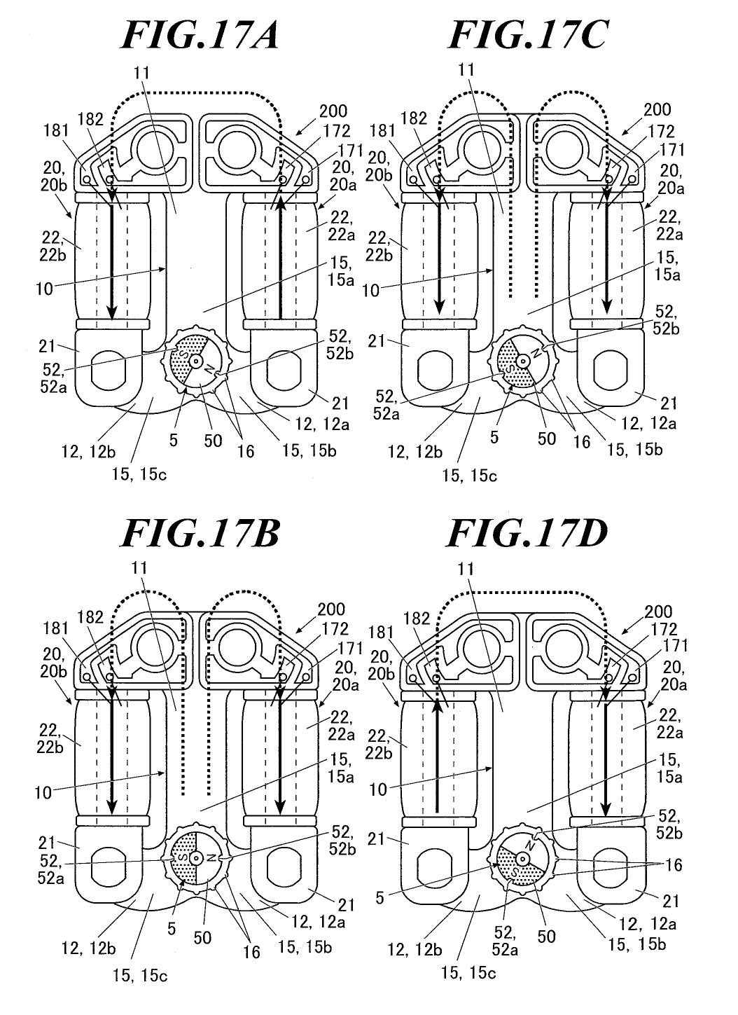

In the next stage, the driving pulse supplying circuit 31 selects “mode 5” in the segment (8) and applies −1.0 mA driving pulse with a pulse width T₃ to the first coil 22a and −1.0 mA driving pulse with a pulse width T₃ to the second coil 22b. This causes the rotor 5 to rotate further 30 degrees counterclockwise. After the rotor 5 rotates 240 degrees from the initial position as shown in FIG. 17A, the rotor-side notches 52a, 52b face the respective stator-side notches 16. The rotor 5 holds this position in a magnetically stable state.

In the next stage, the driving pulse supplying circuit 31 selects “mode 5” in the segment (9) and applies −1.0 mA driving pulse with a pulse width T₂ to the first coil 22a and −1.0 mA driving pulse with a pulse width T₂ to the second coil 22b. This causes the rotor 5 to rotate further 30 degrees counterclockwise. After the rotor 5 rotates 270 degrees from the initial position as shown in FIG. 17B, the rotor-side notches 52a, 52b face the respective stator-side notches 16. The rotor 5 holds this position in a magnetically stable state.

In the next stage, the driving pulse supplying circuit 31 selects “mode 2” in the segment (10) and applies 1.0 mA driving pulse with a pulse width T₀ to the first coil 22a and −1.0 mA driving pulse with a pulse width T₀ to the second coil 22b. This causes the rotor 5 to rotate further 30 degrees counterclockwise. After the rotor 5 rotates 300 degrees from the initial position as shown in FIG. 17C, the rotor-side notches 52a, 52b face the respective stator-side notches 16. The rotor 5 holds this position in a magnetically stable state.

In the next stage, the driving pulse supplying circuit 31 selects “mode 2” in the segment (11) and applies 1.0 mA driving pulse with a pulse width T₀ to the first coil 22a and −1.0 mA driving pulse with a pulse width T₀ to the second coil 22b. This causes the rotor 5 to rotate further 30 degrees counterclockwise. After the rotor 5 rotates 330 degrees from the initial position as shown in FIG. 17D, the rotor-side notches 52a, 52b face the respective stator-side notches 16. The rotor 5 holds this position in a magnetically stable state.

In the next stage, the driving pulse supplying circuit 31 selects “mode 1” in the segment (12) and applies 1.0 mA driving pulse with a pulse width T₂ to the first coil 22a and 1.0 mA driving pulse with a pulse width T₂ to the second coil 22b. This causes the rotor 5 to rotate further 30 degrees counterclockwise and return to the initial position as shown in FIG. 15A. The rotor 5 holds this position in a magnetically stable state.

As in the case of the first embodiment, the rotor in the present embodiment may be rotated 360 degrees clockwise (in the normal direction). To achieve such a clockwise rotation, the driving pulse supplying circuit 31 properly selects the application pattern (mode) of driving pulses in each segment of the driving pulses and applies a driving pulse to the coils 22 in the mode selected.

The lengths of T₀, T₂, and T₃ (the pulse widths) indicated above are exemplary; they can have other suitable values provided that the relationship “T₃<T₂<T₀” holds true.

In the third embodiment, the driving pulse supplying circuit 31 modifies the pulse width of the driving pulses. Alternatively, it may modify the amperage of the driving pulses. For example, an application of 1.0 mA driving pulse with a pulse width T₀, an application of 0.8 mA driving pulse with a pulse width T₀, and an application of 0.6 mA driving pulse with a pulse width T₀ may be used.

The other operations are identical to those in the first embodiment and the redundant description thereof is omitted.

As described above, the third embodiment can provide the same advantageous effects as the first embodiment and additional advantageous effects below.

The driving pulse supplying circuit 31 in accordance with the present embodiment applies driving pulses to both coils 22 in all segments (1) to (12) to rotate the rotor 5. This allows the driving of the rotor 5 at high speed through the maximum rotation torque.

### Fourth Embodiment

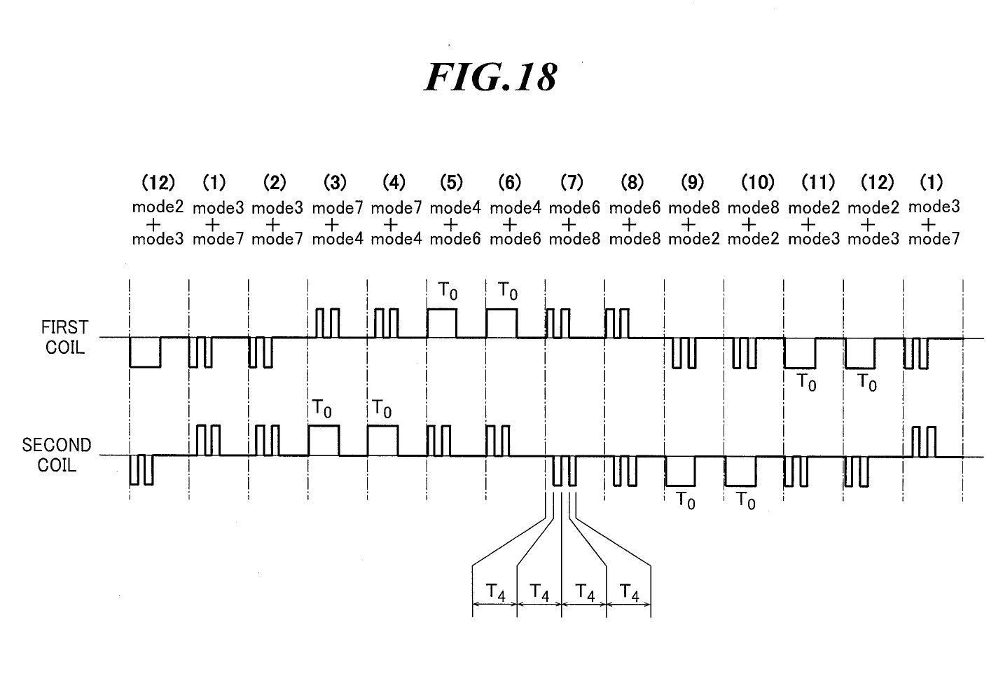

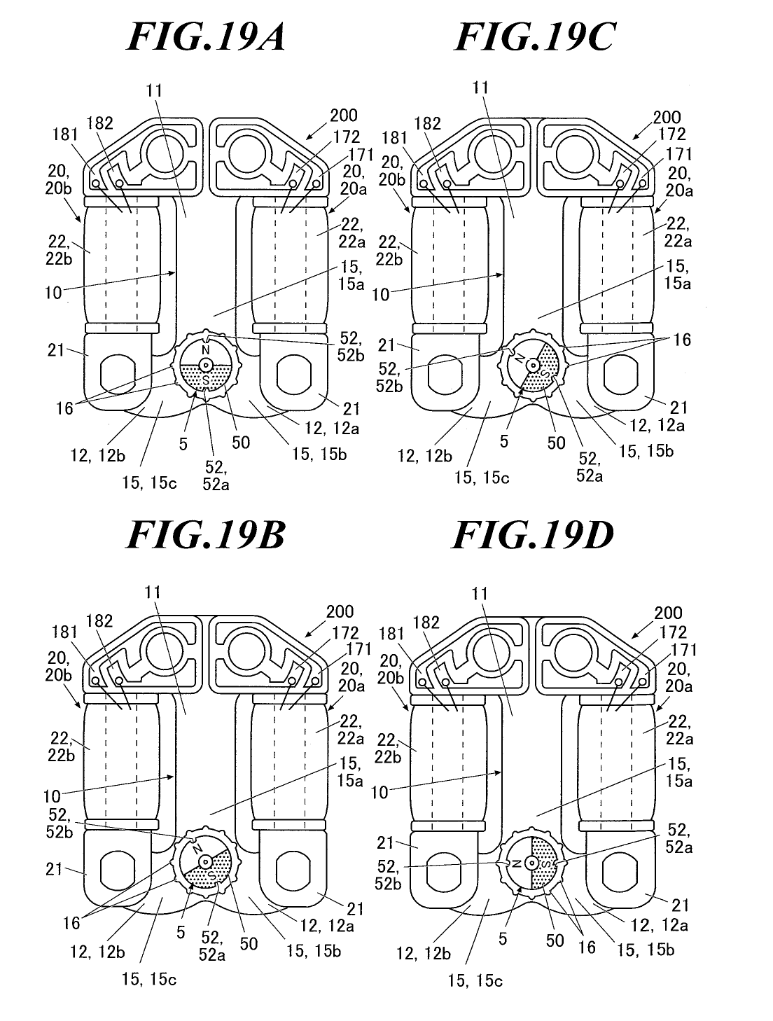

With reference to FIG. 18, FIGS. 19A to 19D, FIGS. 20A to 20D and FIGS. 21A to 21D, a stepping motor will now be described in accordance with a fourth embodiment of the present invention. This embodiment differs from the first embodiment in the way of applying the driving pulses from the driving pulse supplying circuit 31, and therefore only such differences will be described below.

FIG. 18 is a timing chart illustrating the application of the driving pulses from the driving pulse supplying circuit 31, and the application pattern (mode) of the driving pulses in each segment of driving pulses in accordance with this embodiment.

As shown in FIG. 18, the driving pulse supplying circuit 31 alternately selects an application pattern (mode) that increases the torque or an application pattern (mode) that reduces the torque in each segment to finely switch the application pattern (mode), whereby the driving pulses are applied to the coil 22.

Combination of such application patterns (modes) can incorporate driving pulses that can rotate and brake the rotor 5, resulting in a reliable halt of the rotor 5 at a desired step angle (30 degrees in this embodiment) and thus a precise rotational control of the rotor.

The other components are identical to those in the first embodiment and thus are referred to by the same reference signs without redundant description.

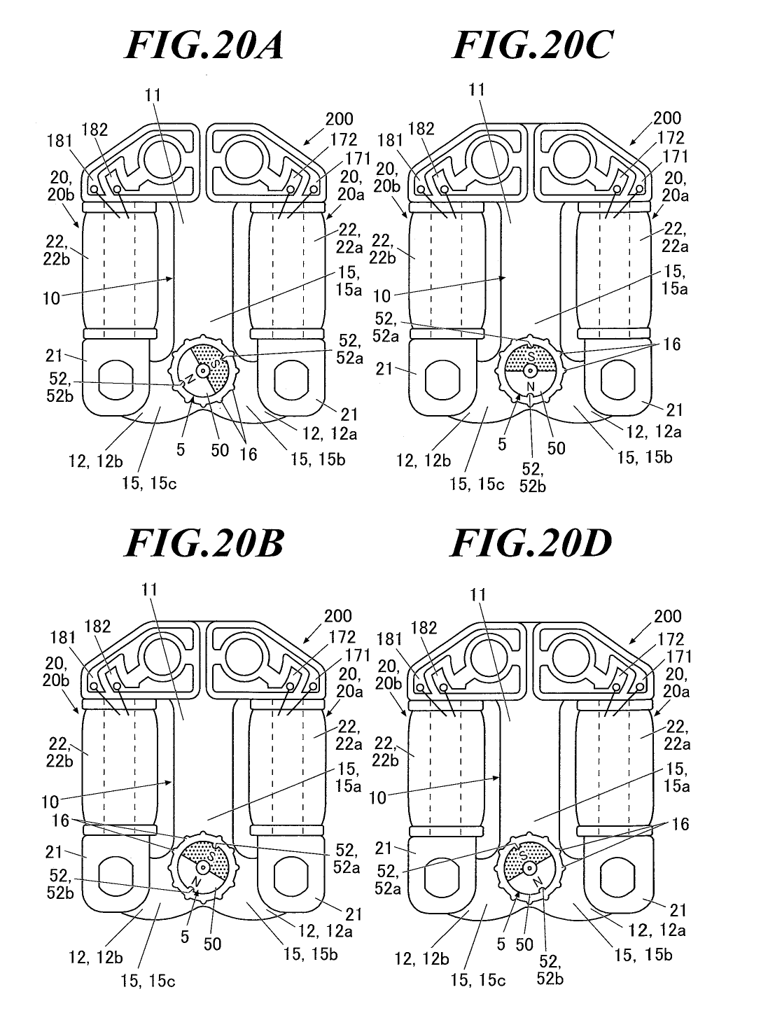

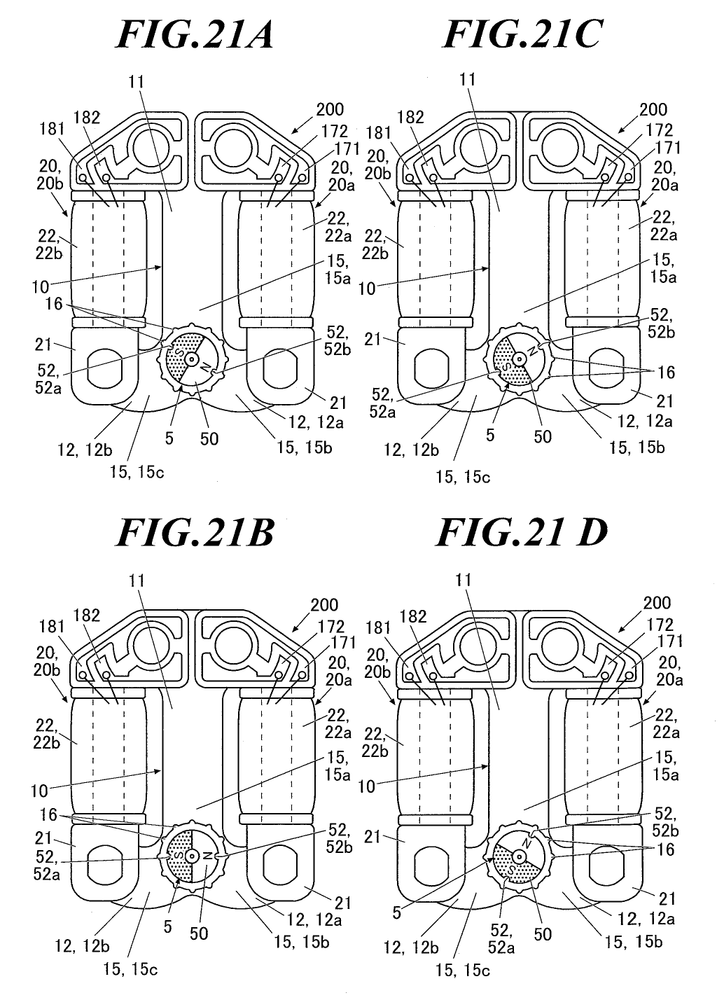

The operation of the stepping motor 200 in accordance with the present embodiment will now be described with reference to FIG. 18, FIG. 19A to 19D, FIGS. 20A to 20D and FIGS. 21A to 21D. In FIG. 19A to 19D, FIGS. 20A to 20D and FIGS. 21A to 21D, solid arrows indicate the direction of the magnetic flux caused by the coil 22 to which driving pulses are applied; dashed arrows indicate the flow of the magnetic flux through the stator 1.

The following description will focus on an example stepping motor 200 in accordance with the fourth embodiment in which the rotor 5 is rotated 360 degrees counterclockwise (in the reverse direction) from an initial position shown in FIG. 19A in steps of 30 degrees, as in the case of the first embodiment.

In the first stage, the rotor 5 is in the initial position shown in FIG. 19A. As shown in FIG. 18, the driving pulse supplying circuit 31 selects “mode 3” and “mode 7” in the segment (1) and controls fine switching between “mode 3” and “mode 7” to alternately apply the driving pulse in “mode 3” or “mode 7.”

In particular, the driving pulse supplying circuit 31 applies 1.0 mA driving pulse with a pulse width T₄ (for example, “T₄” is “T₀/4,” hereinafter “T₄” has the same value) to the first coil 22a in “mode 3.” The driving pulse supplying circuit 31 then applies 1.0 mA driving pulse with a pulse width T₄ to the second coil 22b in “mode 7.” The driving pulse supplying circuit 31 repeats the alternate application of the driving pulse in “mode 3” or “mode 7” in every pulse width T₄.

Such alternate application causes the rotor 5 to start its rotation counterclockwise. After the rotor 5 is rotated 30 degrees counterclockwise from the initial position as shown in FIG. 19B, the rotor-side notches 52a, 52b face the respective stator-side notches 16. The rotor 5 holds this position in a magnetically stable state.

In the second stage, the driving pulse supplying circuit 31 selects “mode 3” and “mode 7” in the segment (2), and controls fine switching between “mode 3” and “mode 7” to alternately apply the driving pulse in “mode 3” or “mode 7” as in the segment (1).

Such alternate application causes the rotor 5 to rotate further 30 degrees counterclockwise. After the rotor rotates 60 degrees from the initial position as shown in FIG. 19C, the rotor-side notches 52a, 52b face the respective stator-side notches 16. The rotor 5 holds this position in a magnetically stable state.

In the third stage, the driving pulse supplying circuit 31 selects “mode 7” and “mode 4” in the segment (3) and controls fine switching between “mode 7” and “mode 4” to alternately apply the driving pulse in “mode 7” or “mode 4.”

In particular, the driving pulse supplying circuit 31 applies 1.0 mA driving pulse with a pulse width T₄ to the second coil 22b in “mode 7.” The driving pulse supplying circuit 31 then applies −1.0 mA driving pulse with a pulse width T₄ to the first coil 22a and 1.0 mA driving pulse with a pulse width T₄ to the second coil 22b in “mode 4.” The driving pulse supplying circuit 31 repeats the alternate application of the driving pulse in “mode 7” or “mode 4” in every pulse width T₄.

In this state, the driving pulses are applied to the second coil 22b continuously. In the segment (3), 1.0 mA of a driving pulse with a pulse width “T₄”×4=“T₀” (for example, 0.7 msec, hereinafter “T₀” has the same value) is applied to the second coil 22b.

Such alternate application of the driving pulses causes the rotor 5 to rotate further 30 degrees counterclockwise. After the rotor 5 rotates 90 degrees from the initial position as shown in FIG. 19D, the rotor-side notches 52a, 52b face the respective stator-side notches 16. The rotor 5 holds this position in a magnetically stable state.

In the next stage, the driving pulse supplying circuit 31 selects “mode 7” and “mode 4” in the segment (4), and controls fine switching between “mode 7” and “mode 4” to alternately apply the driving pulse in “mode 7” or “mode 4” as in the segment (3).

Such alternate application causes the rotor 5 to rotate further 30 degrees counterclockwise. After the rotor rotates 120 degrees from the initial position as shown in FIG. 20A, the rotor-side notches 52a, 52b face the respective stator-side notches 16. The rotor 5 holds this position in a magnetically stable state.

In the next stage, the driving pulse supplying circuit 31 selects “mode 4” and “mode 6” in the segment (5) and controls fine switching between “mode 4” and “mode 6” to alternately apply the driving pulse in “mode 4” or “mode 6.”

In particular, the driving pulse supplying circuit 31 applies −1.0 mA driving pulse with a pulse width T₄ to the first coil 22a and 1.0 mA driving pulse with a pulse width T₄ to the second coil 22b in “mode 4.” The driving pulse supplying circuit 31 then applies −1.0 mA driving pulse with a pulse width T₄ to the first coil 22a in “mode 6.” The driving pulse supplying circuit 31 repeats the alternate application of the driving pulse in “mode 4” or “mode 6” in every pulse width T₄.

In this state, the driving pulses are applied to the first coil 22a continuously. In the segment (5), 1.0 mA driving pulse with a pulse width “T₄”×4=“T₀” is applied to the first coil 22a.

Such alternate application of the driving pulses causes the rotor 5 to rotate further 30 degrees counterclockwise. After the rotor 5 rotates 150 degrees from the initial position as shown in FIG. 20B, the rotor-side notches 52a, 52b face the respective stator-side notches 16. The rotor 5 holds this position in a magnetically stable state.

In the next stage, the driving pulse supplying circuit 31 selects “mode 4” and “mode 6” in the segment (6), and controls fine switching between “mode 4” and “mode 6” to alternately apply the driving pulse in “mode 4” or “mode 6” as in the segment (5).

Such alternate application causes the rotor 5 to rotate further 30 degrees counterclockwise. After the rotor rotates 180 degrees from the initial position as shown in FIG. 20C, the rotor-side notches 52a, 52b face the respective stator-side notches 16. The rotor 5 holds this position in a magnetically stable state.

In the next stage, the driving pulse supplying circuit 31 selects “mode 6” and “mode 8” in the segment (7) and controls fine switching between “mode 6” and “mode 8” to alternately apply the driving pulse in “mode 6” or “mode 8.”

In particular, the driving pulse supplying circuit 31 applies −1.0 mA driving pulse with a pulse width T₄ to the first coil 22a in “mode 6.” The driving pulse supplying circuit 31 then applies −1.0 mA driving pulse with a pulse width T₄ to the second coil 22b in “mode 8.” Then, the driving pulse supplying circuit 31 repeats the alternate application of the driving pulse in “mode 6” or “mode 8” in every pulse width T₄.

Such alternate application causes the rotor 5 to rotate further 30 degrees counterclockwise. After the rotor rotates 210 degrees from the initial position as shown in FIG. 20D, the rotor-side notches 52a, 52b face the respective stator-side notches 16. The rotor 5 holds this position in a magnetically stable state.

In the next stage, the driving pulse supplying circuit 31 selects “mode 6” and “mode 8” in the segment (8), and controls fine switching between “mode 6” and “mode 8” to alternately apply the driving pulse in “mode 6” or “mode 8” as in the segment (7).

Such alternate application causes the rotor 5 to rotate further 30 degrees counterclockwise. After the rotor rotates 240 degrees from the initial position as shown in FIG. 21A, the rotor-side notches 52a, 52b face the respective stator-side notches 16. The rotor 5 holds this position in a magnetically stable state.

In the next stage, the driving pulse supplying circuit 31 selects “mode 8” and “mode 2” in the segment (9) and controls fine switching between “mode 8” and “mode 2” to alternately apply the driving pulse in “mode 8” or “mode 2.”

In particular, the driving pulse supplying circuit 31 applies −1.0 mA driving pulse with a pulse width T₄ to the second coil 22b in “mode 8.” The driving pulse supplying circuit 31 then applies 1.0 mA driving pulse with a pulse width T₄ to the first coil 22a and −1.0 mA driving pulse with a pulse width T₄ to the second coil 22b in “mode 2.” The driving pulse supplying circuit 31 repeats the alternate application of the driving pulse in “mode 8” or “mode 2” in every pulse width T₄.

In this state, the driving pulses are applied to the second coil 22b continuously. In the segment (9) of the driving pulses, 1.0 mA driving pulse with a pulse width “T₄”×4=“T₀” (for example, 0.7 msec, hereinafter “T₀” has the same value) is applied to the second coil 22b.

Such alternate application of the driving pulses causes the rotor 5 to rotate further 30 degrees counterclockwise. After the rotor 5 rotates 270 degrees from the initial position as shown in FIG. 21B, the rotor-side notches 52a, 52b face the respective stator-side notches 16. The rotor 5 holds this position in a magnetically stable state.

In the next stage, the driving pulse supplying circuit 31 selects “mode 8” and “mode 2” in the segment (10), and controls fine switching between “mode 8” and “mode 2” to alternately apply the driving pulse in “mode 8” or “mode 2” as in the segment (9).

Such alternate application causes the rotor 5 to rotate further 30 degrees counterclockwise. After the rotor rotates 300 degrees from the initial position as shown in FIG. 21C, the rotor-side notches 52a, 52b face the respective stator-side notches 16. The rotor 5 holds this position in a magnetically stable state.

In the next stage, the driving pulse supplying circuit 31 selects “mode 2” and “mode 3” in the segment (11) and controls fine switching between “mode 2” and “mode 3” to alternately apply the driving pulse in “mode 2” or “mode 3.”

In particular, the driving pulse supplying circuit 31 applies 1.0 mA driving pulse with a pulse width T₄ to the first coil 22a and −1.0 mA driving pulse with a pulse width T₄ to the second coil 22b in “mode 2.” The driving pulse supplying circuit 31 then applies 1.0 mA driving pulse with a pulse width T₄ to the first coil 22a in “mode 3.” The driving pulse supplying circuit 31 repeats the alternate application of the driving pulse in “mode 2” or “mode 3” in every pulse width T₄.

In this state, the driving pulses are applied to the first coil 22a continuously. In the segment (11), 1.0 mA driving pulse with a pulse width “T₄”×4=“T₀” is applied to the first coil 22a.

Such alternate application of the driving pulses causes the rotor 5 to rotate further 30 degrees counterclockwise. After the rotor 5 rotates 330 degrees from the initial position as shown in FIG. 21D, the rotor-side notches 52a, 52b face the respective stator-side notches 16. The rotor 5 holds this position in a magnetically stable state.

In the next stage, the driving pulse supplying circuit 31 selects “mode 2” and “mode 3” in the segment (12), and controls fine switching between “mode 2” and “mode 3” to alternately apply the driving pulse in “mode 2” or “mode 3” as in the segment (11).

Such alternate application causes the rotor 5 to rotate further 30 degrees counterclockwise and return to the initial position shown in FIG. 19A. The rotor 5 holds this position in a magnetically stable state.

As in the case of the first embodiment, the rotor in the present embodiment may be rotated 360 degrees clockwise (in the normal direction). To achieve such a clockwise rotation, the driving pulse supplying circuit 31 properly selects the application pattern (mode) of driving pulses in each segment of the driving pulses and applies driving pulses to the coils 22 in the mode selected.

The other operations are identical to those in the first embodiment and the redundant description thereof is omitted.

As described above, the fourth embodiment can provide the same advantageous effects as the first embodiment and additional advantageous effects below.

In this embodiment, the driving pulse supplying circuit 31 alternately selects an application pattern (mode) that increases the torque or an application pattern (mode) that reduces the torque in each segment of the driving pulses to finely switch the application pattern (mode), whereby the driving pulses are applied to the coils 22.

Combination of such application patterns (modes) can incorporate driving pulses that can rotate and brake the rotor 5, resulting in a reliable halt of the rotor 5 at a desired step angle (30 degrees in this embodiment) and thus a precise rotational control.

The invention should not be limited to the embodiments described above, and the embodiments may be modified in various manners within the gist of the invention.

For example, the stator 1 in each embodiment includes two coil blocks 20 (the first coil block 20a and the second coil 20b). Alternatively, the number of the coil block included in the stator 1 may be any number other than two. For example, the stator 1 may include three or more coil blocks. Alternatively, it may include one coil block. In a stator 1 including one coil block, the rotor 5 may be rotated continuously at a fine step angle by adjusting the application pattern of the driving pulse and the applying time of the driving pulse.

The stator 1 preferably includes a plurality of coil blocks because such a configuration allows increased torque and increased number of application patterns of driving pulses, whereby various modes are available depending on the purpose.

In the embodiments, the rotor-side notches 52 are provided at both magnetic poles (the S pole and the N pole) of the rotor magnet 50. The present invention is not limited to this configuration. For example, a rotor-side notch 52 may be provided at at least one of the magnetic poles of the rotor magnet 50.

The rotor-side notch 52 when magnetized is preferably at the top of the magnetic pole of the rotor magnet 50. Alternatively, it may be at any other suitable position; the rotor-side notch 52 may be at the top of or in the proximate position to the magnetic pole of the rotor magnet 50 and may be at a position shifted from the top to some degree.

The rotor-side stoppers and the stator-side stoppers in the embodiments may have any suitable shape other than that described in the embodiments provided that these portions have the sufficient index torque (holding torque) to maintain the stationary state of the rotor 5.

For example, the rotor-side stopper on the rotor 5 may be a protrusion projecting from the outer periphery of the rotor magnet 50 toward the inner periphery of the rotor accommodating space 14. In this case, the stator-side stopper on the stator 1 should also be a protrusion projecting toward the rotor magnet 50.

The embodiments show an example rotor magnet 50 having a cylindrical shape. Alternatively, the rotor magnet 50 may have any suitable shape other than a cylinder. An example rotor magnet 50 may have a cubic shape.

In the embodiments, the rotor 5 is rotated by a fine step angle of 30 degrees at a time. Alternatively, the rotor 5 may be rotated by a large angle such as 120 or 180 degrees through modifying the application of the driving pulse as required.

The driving pulse supplying circuit 31 may use any suitable technique to apply driving pulses other than those described in the embodiments.

For example, the driving pulse supplying circuit 31 may properly switch the two or more techniques described in the embodiments as required.

In the embodiments, the stator body 10, the first coil block 20a, and the second coil block 20b are separately formed and are magnetically coupled with one another to constitute the stator 1. The stator 1 may have any configuration other than that shown in the embodiments.

For example, the stator may be made of a stator body and a coil block including an integrated long magnetic core.

In this case, in a stator body including a center yoke and a pair of side yokes as in the embodiments, for example, a substantially center portion of the magnetic core of the coil block is magnetically coupled with the center yoke of the stator body, the coupling portion is provided on both sides thereof with the first coil and the second coil, and one end of the magnetic core is magnetically coupled with one end of one of the side yokes while the other end of the magnetic core is magnetically coupled with one end of the other side yokes.

The resulting stator includes a reduced number of components as compared to the stator including a pair of coil blocks.

The stator body, the first coil block and the second coil block may be integrated into one piece to constitute a stator. In this case, for example, the stator body, the magnetic core of the first coil block, and the magnetic core of the second coil block are integrated into one piece.

The stator, and the stator body, the first coil block and the second coil block, which are components of the stator, may have any shape and configuration other than those described in the embodiments.

In the embodiments, the stepping motor drives a driving mechanism to rotate hands of a timepiece.

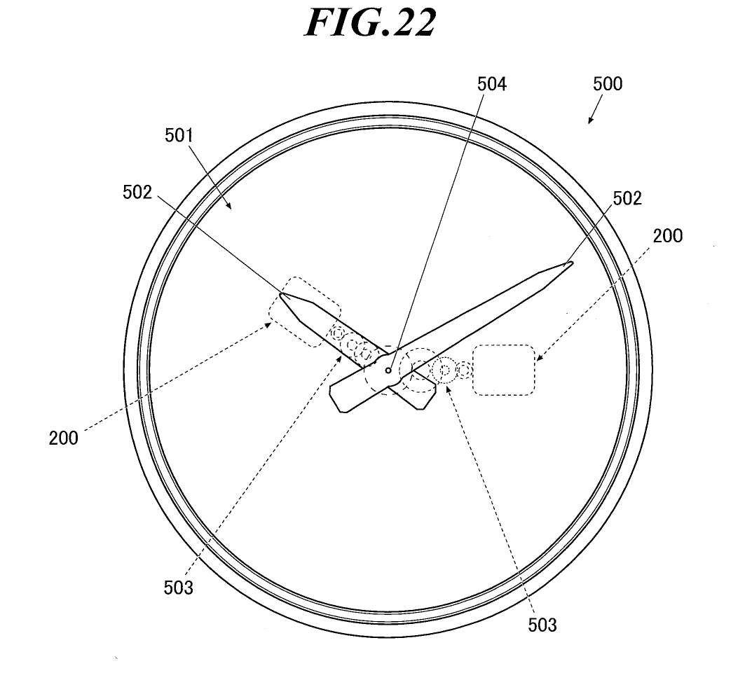

For example, with reference to FIG. 22, in the stepping motor 200 of the embodiments installed in a timepiece 500 including an analogue display 501, a rotary shaft 51 of a rotor 5 is coupled with a gear wheel constituting a driving mechanism (gear train mechanism) 503 to rotate hands 502 (FIG. 22 illustrates an hour hand and a minute hand only. The hands may have any other configuration). In response to the rotation of the rotor 5 of the stepping motor 200 transmitted through the driving mechanism 503, the hands 502 rotate around a hand shaft 504 on the analogue display 501.

In the stepping motor 200 that includes two coils 22 in the embodiments and that drives the driving mechanism of a timepiece, the rotation of the rotor 5 can be readily and accurately detected and the rotation of the stepping motor 200 can be controlled at high precision. This configuration allows the stepping motor 200 to turn the hands at high precision.

The stepping motor 200 may drive any device other than the turning mechanism of a timepiece.

The invention should not be limited to the embodiments described above, and the embodiments may be appropriately modified.

The entire disclosure of Japanese Patent Application No. 2013-195429 filed on Sep. 20, 2013 and Japanese Patent Application No. 2014-144111 filed on Jul. 14, 2014 including description, claims, drawings and abstract are incorporated herein by reference in its entirely.

Although various exemplary embodiments have been shown and described, the invention is not limited to the embodiments shown. Therefore, the scope of the invention is intended to be limited solely by the scope of the claims that follows.

What is claimed is:

1. A stepping motor, comprising:
a rotor including a cylindrical rotor magnet having an M number of magnetization, M being an even number, in a radial direction;
a stator including a stator body and a coil, the stator body having a rotor accommodating space which accommodates the rotor and an N number of magnetic poles, N being an odd number, disposed along an outer periphery of the rotor, and the coil being magnetically coupled with the stator body;
rotor stoppers disposed at every predetermined rotation angle which is smaller than an angle obtained by dividing one rotation by a product of the N and the M; and
a driving pulse supplying circuit which applies driving pulses to rotate the rotor by the predetermined rotation angle to the coil.

2. The stepping motor according to claim 1, wherein the rotor stoppers include:
rotor-side notches formed along an outer periphery of the rotor magnet at a top of a magnetic pole or at a proximate position to the top; and
stator-side notches formed along an inner periphery of the rotor accommodating space of the stator at equal intervals, each stator-side notch having a witch which nearly matches a witch of the rotor-side notch.

3. The stepping motor according to claim 1, wherein
the stator includes two coils, and
the driving pulse supplying circuit applies the driving pulses to the coils in an appropriately selected application pattern among a plurality of application patterns by applying or not applying the driving pulses to the coils and by switching a direction of the driving pulses when applied.

4. The stepping motor according to claim 1, wherein
the driving pulse supplying circuit selects an application pattern on a basis of a stopping angle position of the rotor stopped by the rotor stoppers with respect to the stator.

5. The stepping motor according to claim 4, wherein
the driving pulse supplying circuit selects an application pattern of different pulse witch on a basis of the stopping angle position of the rotor stopped by the rotor stoppers with respect to the stator.

6. The stepping motor according to claim 4, wherein
the driving pulse supplying circuit selects an application pattern that alternately carries out a plurality of application patterns on a basis of the stopping angle position of the rotor stopped by the rotor stoppers with respect to the stator.

7. A timepiece, comprising:
a stepping motor which comprises,
a rotor including a cylindrical rotor magnet having an M number of magnetization, M being an even number, in a radial direction;
a stator including a stator body and a coil, the stator body having a rotor accommodating space which accommodates the rotor and an N number of magnetic poles, N being an odd number, disposed along an outer periphery of the rotor, and the coil being magnetically coupled with the stator body;
rotor stoppers disposed at every predetermined rotation angle which is smaller than an angle obtained by dividing one rotation by a product of the N and the M; and
a driving pulse supplying circuit which applies driving pulses to rotate the rotor by the predetermined rotation angle to the coil.
